(19) United States
(12) Patent Application Publication
(10) Pub. No.: US 2026/0234032 A1
(43) Pub. Date: Aug. 13, 2026

(54) METHOD AND APPARATUS FOR ELECTROCHEMICAL ION EXCHANGE

(71) Applicant: Lithios Inc., Cambridge, MA (US)

(72) Inventors: Matthew E. Suss, Newton, MA (US); Michael J. Wang, Cambridge, MA (US); Martin Z. Bazant, Wellesley, MA (US); Mohammad A. Alkhadra, Boston, MA (US)

(73) Assignee: Lithios Inc., Cambridge, MA (US)

(21) Appl. No.: 19/150,487

(22) PCT Filed: Jan. 23, 2024
(86) PCT No.: PCT/US2024/012496

§ 371 Date: Jul. 23, 2025

Related U.S. Application Data
(60) Provisional application No. 63/440,889, filed on Jan. 24, 2023.
(60) Provisional application No. 63/444,484, filed on Feb. 9, 2023.
(60) Provisional application No. 63/513,519, filed on Jul. 13, 2023.
(60) Provisional application No. 63/513,532, filed on Jul. 13, 2023.
(60) Provisional application No. 63/513,538, filed on Jul. 13, 2023.

(51) Int. Cl. C02F 1/461; C02F 101/10; C02F 103/02; C02F 103/08; C02F 103/10; C02F 103/34

(52) U.S. Cl. CPC C02F 1/46109; C02F 2001/46138; C02F 2001/46161; C02F 2101/10; C02F 2103/02; C02F 2103/08; C02F 2103/10; C02F 2103/34; C02F 2201/4611; C02F 2201/46145

(57) ABSTRACT

The present disclosure generally relates to apparatuses and methods for extraction of ions, including lithium ions. For example, certain aspects are generally directed to electrochemical ion exchange techniques, in which ion exchange is driven by electricity. In some embodiments, a fluid rich in target ions (e.g., a feed solution) may be present in a compartment containing a target-ion selective electrode, and target ions from the fluid may be incorporated into the electrode, e.g., by applying a suitable current to drive ion exchange. At a second time, the target ions may be removed from the electrode, e.g., into a fluid poor in target ions (e.g., a recovery solution), for example, by applying a suitable current to drive ion exchange. In addition, certain embodiments are generally directed to a stack of such compartments.

### RELATED APPLICATIONS

This application claims the benefit of U.S. Provisional Patent Application Ser. No. 63/440,889, filed Jan. 24, 2023, entitled “Methods and Apparatuses for Galvanic Ion Extraction”; U.S. Provisional Patent Application Ser. No. 63/444,484, filed Feb. 9, 2023, entitled “Flow Field Configurations and Methods for Separation Processes”; U.S. Provisional Patent Application Ser. No. 63/513,519, filed Jul. 13, 2023, entitled “Methods and Apparatuses for Electrochemical Ion Exchange”; U.S. Provisional Patent Application Ser. No. 63/513,532, filed Jul. 13, 2023, entitled “Processes and Apparatuses for Enriching Solutions”; and U.S. Provisional Patent Application Ser. No. 63/513,538, filed Jul. 13, 2023, entitled “Flow Systems and Methods for Membraneless Separation.” Each of the above is incorporated herein by reference.

### FIELD

The present disclosure generally relates to apparatuses and methods for extraction of ions, including lithium ions.

### BACKGROUND

Ion exchange is often employed in many industrial processes, for example, to exchange calcium ions for sodium ions in water softening. Ion exchange involves the use of a specialized resin material having an affinity to target ions in a fluid. Once fully saturated, the resin can be regenerated via chemical treatment, such as by exposing it to hydrochloric acid. However, the use and disposal of such chemical regenerants is a major drawback of ion exchange, limiting its use. Accordingly, improvements in ion exchange processes are needed.

### SUMMARY

The present disclosure generally relates to apparatuses and methods for extraction of ions, including lithium ions. The subject matter of the present disclosure involves, in some cases, interrelated products, alternative solutions to a particular problem, and/or a plurality of different uses of one or more systems and/or articles.

In some aspects, ion exchange may be performed as discussed herein without requiring chemical regenerants. For example, in accordance with certain embodiments, ion exchange may be driven via electricity, e.g., in forward or reverse directions. For instance, in certain cases, the active elements (electrodes) may be discharged electrically to regenerate them.

As an example, one set of embodiments is generally directed to an electrochemical cell or compartment comprising a first electrode and a second electrode. Fluid may be present in and/or flow through the compartment. The fluid within the compartment may include feed solutions (e.g., a solution that is lithium-rich or rich in other target ions), or recovery solutions (e.g., a solution that is lithium-poor or poor in other target ions), depending on the application and the mode of operation. In one embodiment, a feed solution may be present or flow through the compartment during discharging, and the first electrode may selectively remove cations from the feed solution, such as lithium, while the second electrode may expel other cations into the feed solution, such as magnesium. During charging, a recovery solution may be present or flow through the compartment, and the recovery solution may accept cations that are expelled from the first electrode, such as lithium, while the second electrode can remove other cations from the recovery solution, such as magnesium. Other examples of cations are described below. These operations may be driven by applying a current to the electrodes. In addition, in certain embodiments, such those as discussed herein, recovery stream purification and cation recovery can be performed simultaneously.

In addition, certain embodiments are generally directed to methods or apparatuses for extracting a target ion (e.g., metal ions such as lithium, or others) from a multicomponent aqueous solution containing certain target ions by electroswing adsorption or other processes. In some cases, the apparatus may include one or more compartments (e.g., a stack of compartments) containing target ion-selective working electrodes and a divalent, multivalent, or monovalent cation-selective counter electrode. Some or all of the compartments may contain fluid, or allow fluid flow, e.g., where feed and recovery solutions can be exchanged during a cycle of target ion extraction and release, respectively. In addition, the counter electrode may be used to selectively electrosorb target cations during cell charging and desorb them during cell discharging, and/or to selectively electrosorb target anions during cell discharging and desorb them during cell charging.

One aspect is generally directed to an apparatus for electrochemical extraction of lithium. In one set of embodiments, the apparatus comprises a compartment containing a lithium-selective electrode and a divalent and/or multivalent cation-selective electrode; an electrical pathway connecting the lithium-selective electrode and the divalent and/or multivalent cation-selective electrode; a source of lithium-rich fluid; a source of lithium-poor fluid; and a flow-switching element able to direct fluid from either the source of lithium-rich fluid or the source of lithium-poor fluid to the compartment.

In another set of embodiments, the apparatus comprises a stack comprising a plurality of repeat units, each repeat unit comprising a compartment containing a lithium-selective electrode and a divalent and/or multivalent cation-selective electrode, and an electrical pathway connecting the lithium-selective electrode and the divalent and/or multivalent cation-selective electrode; a source of lithium-rich fluid; a source of lithium-poor fluid; and a flow-switching element able to direct fluid from either the source of lithium-rich fluid or the source of lithium-poor fluid to the compartments within the stack.

Another aspect is generally directed at an apparatus for electrochemical extraction of target monovalent ion. In one set of embodiments, the apparatus comprises a compartment containing a target monovalent ion-selective electrode and a multivalent cation-selective electrode; an electrical pathway connecting the target monovalent ion-selective electrode and the multivalent cation-selective electrode; a source of target monovalent ion-rich fluid; a source of target monovalent ion-poor fluid; and a flow-switching element able to direct fluid from either the source of target monovalent ion-rich fluid or the source of target monovalent ion-poor fluid to the compartment.

The apparatus, in another set of embodiments, comprises a stack comprising a plurality of repeat units, each repeat unit comprising a compartment containing a target monovalent ion-selective electrode and a multivalent cation-selective electrode, and an electrical pathway connecting the target monovalent ion-selective electrode and the multivalent cation-selective electrode; a source of target monovalent ion-rich fluid; a source of target monovalent ion-poor fluid; and a flow-switching element able to direct fluid from either the source of target monovalent ion-rich fluid or the source of target monovalent ion-poor fluid to the compartments within the stack.

Yet another aspect is generally drawn to an apparatus for electrochemical extraction of lithium. In one set of embodiments, the apparatus comprises a compartment containing a lithium-selective electrode and a monovalent cation-selective electrode, wherein the monovalent cation is not lithium; an electrical pathway connecting the lithium-selective electrode and the monovalent cation-selective electrode; a source of lithium-rich fluid; a source of lithium-poor fluid; and a flow-switching element able to direct fluid from either the source of lithium-rich fluid or the source of lithium-poor fluid to the compartment.

The apparatus, in another set of embodiments, comprises a stack comprising a plurality of repeat units, each repeat unit comprising a compartment containing a lithium-selective electrode and a monovalent cation-selective electrode, and an electrical pathway connecting the lithium-selective electrode and the monovalent cation-selective electrode, wherein the monovalent cation is not lithium; a source of lithium-rich fluid; a source of lithium-poor fluid; and a flow-switching element able to direct fluid from either the source of lithium-rich fluid or the source of lithium-poor fluid to the compartments within the stack.

The apparatus, in another aspect, may be an apparatus for electrochemical extraction of target monovalent ion. In one set of embodiments, the apparatus comprises a compartment containing a target monovalent ion-selective electrode and a non-target monovalent cation-selective electrode; an electrical pathway connecting the target monovalent ion-selective electrode and the multivalent cation-selective electrode; a source of target monovalent ion-rich fluid; a source of target monovalent ion-poor fluid; and a flow-switching element able to direct fluid from either the source of target monovalent ion-rich fluid or the source of target monovalent ion-poor fluid to the compartment.

The apparatus, in another set of embodiments, comprises a stack comprising a plurality of repeat units, each repeat unit comprising a compartment containing a target monovalent ion-selective electrode and a non-target monovalent cation-selective electrode, and an electrical pathway connecting the target monovalent ion-selective electrode and the non-target monovalent cation-selective electrode; a source of target monovalent ion-rich fluid; a source of target monovalent ion-poor fluid; and a flow-switching element able to direct fluid from either the source of target monovalent ion-rich fluid or the source of target monovalent ion-poor fluid to the compartments within the stack.

Yet another aspect is generally directed to a method for electrochemical extraction of lithium. In one set of embodiments, the method comprises providing an electrochemical cell comprising a compartment containing a lithium-selective electrode and a divalent and/or multivalent cation-selective electrode; at a first time, causing current to flow from the lithium-selective electrode to the divalent and/or multivalent cation-selective electrode while flowing a lithium-rich fluid through the compartment; and at a second time, causing current to flow from the divalent and/or multivalent cation-selective electrode to the lithium-selective electrode while flowing a lithium-poor fluid through the compartment.

The method, in accordance with another set of embodiments, comprises providing an electrochemical cell comprising a compartment containing a lithium-selective electrode and a divalent and/or multivalent cation-selective electrode; at a first time, flowing a lithium-rich fluid through the compartment, incorporating lithium ions from the lithium-rich fluid into the lithium-selective electrode, and removing divalent and/or multivalent cations from the divalent and/or multivalent cation-selective electrode into the lithium-rich fluid; and at a second time, flowing a lithium-poor fluid through the compartment, removing lithium ions from the lithium-selective electrode into the lithium-poor fluid, and incorporating divalent and/or multivalent cations from the lithium-poor fluid into the divalent and/or multivalent cation-selective electrode.

In another aspect, the method is a method for electrochemical extraction of target monovalent ion. In one set of embodiments, the method comprises providing an electrochemical cell comprising a compartment containing a target monovalent ion-selective electrode and a multivalent cation-selective electrode; at a first time, causing current to flow from the target monovalent ion-selective electrode to the multivalent cation-selective electrode while flowing a target monovalent ion-rich fluid through the compartment; and at a second time, causing current to flow from the multivalent cation-selective electrode to the target monovalent ion-selective electrode while flowing a target monovalent ion-poor fluid through the compartment.

According to another set of embodiments, the method comprises providing an electrochemical cell comprising a compartment containing a target monovalent ion-selective electrode and a multivalent cation-selective electrode; at a first time, flowing a target monovalent ion-rich fluid through the compartment, incorporating target monovalent ion ions from the target monovalent ion-rich fluid into the target monovalent ion-selective electrode, and removing multivalent cations from the multivalent cation-selective electrode into the target monovalent ion-rich fluid; and at a second time, flowing a target monovalent ion-poor fluid through the compartment, removing target monovalent ion ions from the target monovalent ion-selective electrode into the target monovalent ion-poor fluid, and incorporating multivalent cations from the target monovalent ion-poor fluid into the multivalent cation-selective electrode.

Still another aspect is directed to a method for electrochemical extraction of lithium. In one set of embodiments, the method comprises providing an electrochemical cell comprising a compartment containing a lithium-selective electrode and a monovalent cation-selective electrode, wherein the monovalent cation is not lithium; at a first time, causing current to flow from the lithium-selective electrode to the monovalent cation-selective electrode while flowing a lithium-rich fluid through the compartment; and at a second time, causing current to flow from the monovalent cation-selective electrode to the lithium-selective electrode while flowing a lithium-poor fluid through the compartment.

In another set of embodiments, the method comprises providing an electrochemical cell comprising a compartment containing a lithium-selective electrode and a monovalent cation-selective electrode, wherein the monovalent cation is not lithium; at a first time, flowing a lithium-rich fluid through the compartment, incorporating lithium ions from the lithium-rich fluid into the lithium-selective electrode, and removing monovalent cations from the monovalent cation-selective electrode into the lithium-rich fluid; and at a second time, flowing a lithium-poor fluid through the compartment, removing lithium ions from the lithium-selective electrode into the lithium-poor fluid, and incorporating monovalent cations from the lithium-poor fluid into the monovalent cation-selective electrode.

Still another aspect is generally drawn to a method for electrochemical extraction of target monovalent ion. In one set of embodiments, the method comprises providing an electrochemical cell comprising a compartment containing a target monovalent ion-selective electrode and a non-target monovalent cation-selective electrode; at a first time, causing current to flow from the target monovalent ion-selective electrode to the non-target monovalent cation-selective electrode while flowing a target monovalent ion-rich fluid through the compartment; and at a second time, causing current to flow from the non-target monovalent cation-selective electrode to the target monovalent ion-selective electrode while flowing a target monovalent ion-poor fluid through the compartment.

In another set of embodiments, the method comprises providing an electrochemical cell comprising a compartment containing a target monovalent ion-selective electrode and a non-target monovalent cation-selective electrode; at a first time, flowing a target monovalent ion-rich fluid through the compartment, incorporating target monovalent ion ions from the target monovalent ion-rich fluid into the target monovalent ion-selective electrode, and removing non-target monovalent cations from the non-target monovalent cation-selective electrode into the target monovalent ion-rich fluid; and at a second time, flowing a target monovalent ion-poor fluid through the compartment, removing target monovalent ion ions from the target monovalent ion-selective electrode into the target monovalent ion-poor fluid, and incorporating non-target monovalent cations from the target monovalent ion-poor fluid into the non-target monovalent cation-selective electrode.

In certain aspects, the method is a method for electrochemical extraction of lithium. According to one set of embodiments, the method comprises providing a stack comprising a plurality of repeat units, each repeat unit comprising a compartment containing a lithium-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, causing current to flow from the lithium-selective electrodes to the divalent and/or multivalent cation-selective electrodes while flowing a lithium-rich fluid through the first group of compartments, and causing current to flow from the divalent and/or multivalent cation-selective electrodes to the lithium-selective electrodes while flowing a lithium-poor fluid through the second group of compartments; and at a second time, causing current to flow from the lithium-selective electrode to the divalent and/or multivalent cation-selective electrode while flowing the lithium-rich fluid through the second group of compartments, and causing current to flow from the divalent and/or multivalent cation-selective electrodes to the lithium-selective electrodes while flowing a lithium-poor fluid through the first group of compartments.

In another set of embodiments, the method comprises providing a stack comprising a plurality of repeat units, each repeat unit comprising a compartment containing a lithium-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, causing current to flow from the lithium-selective electrodes to the divalent and/or multivalent cation-selective electrodes while flowing a lithium-rich fluid through the first group of compartments; and at a second time, causing current to flow from the lithium-selective electrode to the divalent and/or multivalent cation-selective electrode while flowing the lithium-rich fluid through the second group of compartments.

In yet another set of embodiments, the method comprises providing a stack comprising a plurality of repeat units, each repeat unit comprising a compartment containing a lithium-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, flowing a lithium-rich fluid through the first group of compartments and a lithium-poor fluid through the second group of compartments such that lithium ions from the lithium-rich fluid incorporate into the lithium-selective electrodes and divalent and/or multivalent cations are removed from the divalent and/or multivalent cation-selective electrodes into the lithium-rich fluid in the first group of compartments, and lithium ions are removed from the lithium-selective electrodes into the lithium-poor fluid and divalent and/or multivalent cations from the lithium-poor fluid incorporate into the divalent and/or multivalent cation-selective electrodes in the second group of compartments; and at a second time, flowing the lithium-rich fluid through the second group of compartments and the lithium-poor fluid through the first group of compartments such that lithium ions from the lithium-rich fluid incorporate into the lithium-selective electrodes and divalent and/or multivalent cations are removed from the divalent and/or multivalent cation-selective electrodes into the lithium-rich fluid in the second group of compartments, and lithium ions are removed from the lithium-selective electrodes into the lithium-poor fluid and divalent and/or multivalent cations from the lithium-poor fluid incorporate into the divalent and/or multivalent cation-selective electrodes in the first group of compartments.

The method, in still another set of embodiments, comprises providing a stack comprising a plurality of repeat units, each repeat unit comprising a compartment containing a lithium-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, flowing a lithium-rich fluid through the first group of compartments such that lithium ions from the lithium-rich fluid incorporate into the lithium-selective electrodes and divalent and/or multivalent cations are removed from the divalent and/or multivalent cation-selective electrodes into the lithium-rich fluid in the first group of compartments; and at a second time, flowing the lithium-rich fluid through the second group of compartments such that lithium ions from the lithium-rich fluid incorporate into the lithium-selective electrodes and divalent and/or multivalent cations are removed from the divalent and/or multivalent cation-selective electrodes into the lithium-rich fluid in the second group of compartments.

In another set of embodiments, the method comprises providing a stack comprising a plurality of repeat units, each repeat unit comprising a compartment containing a target monovalent ion-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, causing current to flow from the target monovalent ion-selective electrodes to the divalent and/or multivalent cation-selective electrodes while flowing a target monovalent ion-rich fluid through the first group of compartments; and at a second time, causing current to flow from the target monovalent ion-selective electrode to the divalent and/or multivalent cation-selective electrode while flowing the target monovalent ion-rich fluid through the second group of compartments.

In yet another set of embodiments, the method comprises providing a stack comprising a plurality of repeat units, each repeat unit comprising a compartment containing a target monovalent ion-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, flowing a target monovalent ion-rich fluid through the first group of compartments and a target monovalent ion-poor fluid through the second group of compartments such that target monovalent ion ions from the target monovalent ion-rich fluid incorporate into the target monovalent ion-selective electrodes and divalent and/or multivalent cations are removed from the divalent and/or multivalent cation-selective electrodes into the target monovalent ion-rich fluid in the first group of compartments, and target monovalent ion ions are removed from the target monovalent ion-selective electrodes into the target monovalent ion-poor fluid and divalent and/or multivalent cations from the target monovalent ion-poor fluid incorporate into the divalent and/or multivalent cation-selective electrodes in the second group of compartments; and at a second time, flowing the target monovalent ion-rich fluid through the second group of compartments and the target monovalent ion-poor fluid through the first group of compartments such that target monovalent ion ions from the target monovalent ion-rich fluid incorporate into the target monovalent ion-selective electrodes and divalent and/or multivalent cations are removed from the divalent and/or multivalent cation-selective electrodes into the target monovalent ion-rich fluid in the second group of compartments, and target monovalent ion ions are removed from the target monovalent ion-selective electrodes into the target monovalent ion-poor fluid and divalent and/or multivalent cations from the target monovalent ion-poor fluid incorporate into the divalent and/or multivalent cation-selective electrodes in the first group of compartments.

The method, in still another set of embodiments, comprises providing a stack comprising a plurality of repeat units, each repeat unit comprising a compartment containing a target monovalent ion-selective electrode and a divalent and/or multivalent cation-selective electrode, wherein the compartments comprise a first group of compartments and a second group of compartments, the compartments of the first group of compartments and the compartments of the second group of compartments alternating within the stack; at a first time, flowing a target monovalent ion-rich fluid through the first group of compartments such that target monovalent ion ions from the target monovalent ion-rich fluid incorporate into the target monovalent ion-selective electrodes and divalent and/or multivalent cations are removed from the divalent and/or multivalent cation-selective electrodes into the target monovalent ion-rich fluid in the first group of compartments; and at a second time, flowing the target monovalent ion-rich fluid through the second group of compartments such that target monovalent ion ions from the target monovalent ion-rich fluid incorporate into the target monovalent ion-selective electrodes and divalent and/or multivalent cations are removed from the divalent and/or multivalent cation-selective electrodes into the target monovalent ion-rich fluid in the second group of compartments.

In another set of embodiments, the method comprises providing a stack comprising a plurality of repeat units, each repeat unit comprising a compartment containing a lithium-selective electrode and a monovalent cation-selective electrode (e.g., where the monovalent cation is not lithium), wherein the compartments comprise a first group of compartments and a second group of compartments, the compartments of the first group of compartments and the compartments of the second group of compartments alternating within the stack; at a first time, causing current to flow from the lithium-selective electrodes to the monovalent cation-selective electrodes while flowing a lithium-rich fluid through the first group of compartments; and at a second time, causing current to flow from the lithium-selective electrode to the monovalent cation-selective electrode while flowing the lithium-rich fluid through the second group of compartments.

In yet another set of embodiments, the method comprises providing a stack comprising a plurality of repeat units, each repeat unit comprising a compartment containing a lithium-selective electrode and a monovalent cation-selective electrode, wherein the compartments comprise a first group of compartments and a second group of compartments, the compartments of the first group of compartments and the compartments of the second group of compartments alternating within the stack; at a first time, flowing a lithium-rich fluid through the first group of compartments and a lithium-poor fluid through the second group of compartments such that lithium ions from the lithium-rich fluid incorporate into the lithium-selective electrodes and monovalent cations are removed from the monovalent cation-selective electrodes into the lithium-rich fluid in the first group of compartments, and lithium ions are removed from the lithium-selective electrodes into the lithium-poor fluid and monovalent cations from the lithium-poor fluid incorporate into the monovalent cation-selective electrodes in the second group of compartments; and at a second time, flowing the lithium-rich fluid through the second group of compartments and the lithium-poor fluid through the first group of compartments such that lithium ions from the lithium-rich fluid incorporate into the lithium-selective electrodes and monovalent cations are removed from the monovalent cation-selective electrodes into the lithium-rich fluid in the second group of compartments, and lithium ions are removed from the lithium-selective electrodes into the lithium-poor fluid and monovalent cations from the lithium-poor fluid incorporate into the monovalent cation-selective electrodes in the first group of compartments.

The method, in still another set of embodiments, comprises providing a stack comprising a plurality of repeat units, each repeat unit comprising a compartment containing a lithium-selective electrode and a monovalent cation-selective electrode, wherein the compartments comprise a first group of compartments and a second group of compartments, the compartments of the first group of compartments and the compartments of the second group of compartments alternating within the stack; at a first time, flowing a lithium-rich fluid through the first group of compartments such that lithium ions from the lithium-rich fluid incorporate into the lithium-selective electrodes and monovalent cations are removed from the monovalent cation-selective electrodes into the lithium-rich fluid in the first group of compartments; and at a second time, flowing the lithium-rich fluid through the second group of compartments such that lithium ions from the lithium-rich fluid incorporate into the lithium-selective electrodes and monovalent cations are removed from the monovalent cation-selective electrodes into the lithium-rich fluid in the second group of compartments.

In another set of embodiments, the method comprises providing a stack comprising a plurality of repeat units, each repeat unit comprising a compartment containing a target monovalent ion-selective electrode and a non-target monovalent cation-selective electrode, wherein the compartments comprise a first group of compartments and a second group of compartments, the compartments of the first group of compartments and the compartments of the second group of compartments alternating within the stack; at a first time, causing current to flow from the target monovalent ion-selective electrodes to the non-target monovalent cation-selective electrodes while flowing a target monovalent ion-rich fluid through the first group of compartments; and at a second time, causing current to flow from the target monovalent ion-selective electrode to the non-target monovalent cation-selective electrode while flowing the target monovalent ion-rich fluid through the second group of compartments.

In yet another set of embodiments, the method comprises providing a stack comprising a plurality of repeat units, each repeat unit comprising a compartment containing a target monovalent ion-selective electrode and a non-target monovalent cation-selective electrode, wherein the compartments comprise a first group of compartments and a second group of compartments, the compartments of the first group of compartments and the compartments of the second group of compartments alternating within the stack; at a first time, flowing a target monovalent ion-rich fluid through the first group of compartments and a target monovalent ion-poor fluid through the second group of compartments such that target monovalent ion ions from the target monovalent ion-rich fluid incorporate into the target monovalent ion-selective electrodes and non-target monovalent cations are removed from the non-target monovalent cation-selective electrodes into the target monovalent ion-rich fluid in the first group of compartments, and target monovalent ion ions are removed from the target monovalent ion-selective electrodes into the target monovalent ion-poor fluid and non-target monovalent cations from the target monovalent ion-poor fluid incorporate into the non-target monovalent cation-selective electrodes in the second group of compartments; and at a second time, flowing the target monovalent ion-rich fluid through the second group of compartments and the target monovalent ion-poor fluid through the first group of compartments such that target monovalent ion ions from the target monovalent ion-rich fluid incorporate into the target monovalent ion-selective electrodes and non-target monovalent cations are removed from the non-target monovalent cation-selective electrodes into the target monovalent ion-rich fluid in the second group of compartments, and target monovalent ion ions are removed from the target monovalent ion-selective electrodes into the target monovalent ion-poor fluid and non-target monovalent cations from the target monovalent ion-poor fluid incorporate into the non-target monovalent cation-selective electrodes in the first group of compartments.

The method, in still another set of embodiments, comprises providing a stack comprising a plurality of repeat units, each repeat unit comprising a compartment containing a target monovalent ion-selective electrode and a non-target monovalent cation-selective electrode, wherein the compartments comprise a first group of compartments and a second group of compartments, the compartments of the first group of compartments and the compartments of the second group of compartments alternating within the stack; at a first time, flowing a target monovalent ion-rich fluid through the first group of compartments such that target monovalent ion ions from the target monovalent ion-rich fluid incorporate into the target monovalent ion-selective electrodes and non-target monovalent cations are removed from the non-target monovalent cation-selective electrodes into the target monovalent ion-rich fluid in the first group of compartments; and at a second time, flowing the target monovalent ion-rich fluid through the second group of compartments such that target monovalent ion ions from the target monovalent ion-rich fluid incorporate into the target monovalent ion-selective electrodes and non-target monovalent cations are removed from the non-target monovalent cation-selective electrodes into the target monovalent ion-rich fluid in the second group of compartments.

In yet another set of embodiments, the method comprises providing a stack comprising a plurality of repeat units, each repeat unit comprising a compartment containing a target monovalent ion-selective electrode and a divalent cation-selective electrode; at a first time, flowing a target monovalent ion-rich fluid through the compartments such that target monovalent ion ions from the target monovalent ion-rich fluid incorporate into the target monovalent ion-selective electrodes and divalent cations are removed from the divalent cation-selective electrodes into the target monovalent ion-rich fluid; and at a second time, flowing the target monovalent ion-poor fluid through the compartments such that target monovalent ion ions are removed from the target monovalent ion-selective electrodes into the target monovalent ion-poor fluid and divalent cations from the target monovalent ion-poor fluid incorporate into the divalent cation-selective electrodes.

In another aspect, the present disclosure encompasses methods of making one or more of the embodiments described herein, for example, apparatuses for electrochemical ion extraction of a target cation, such as lithium. In still another aspect, the present disclosure encompasses methods of using one or more of the embodiments described herein, for example, apparatuses for electrochemical ion extraction of a target cation, such as lithium.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A-1B illustrate electrochemical ion exchange of lithium and a divalent ion (M²⁺), in one embodiment;

FIGS. 2A-2B illustrate electrochemical ion exchange of lithium and a different monovalent ion (M⁺), in another embodiment;

FIGS. 3A-3B electrochemical illustrate ion exchange of lithium, an anion (A), and a divalent ion (M²⁺), in yet another embodiment;

FIGS. 4A-4B demonstrate multiple cycles of lithium extraction and removal, in still another embodiment;

FIG. 5 illustrates a compartment with three sets of electrodes, in accordance with one embodiment;

FIG. 6 illustrates a stack of compartments, in another embodiment; and

FIG. 7 illustrates an apparatus with flow-through electrodes, in yet another embodiment.

### DETAILED DESCRIPTION

The present disclosure generally relates to apparatuses and methods for extraction of ions, including lithium ions. For example, certain aspects are generally directed to electrochemical ion exchange techniques, in which ion exchange is driven by electricity. In some embodiments, a fluid rich in target ions (e.g., a feed solution) may be present in a compartment containing a target-ion selective electrode, and target ions from the fluid may be incorporated into the electrode, e.g., by applying a suitable current to drive ion exchange. At a second time, the target ions may be removed from the electrode, e.g., into a fluid poor in target ions (e.g., a recovery solution), for example, by applying a suitable current to drive ion exchange. In addition, certain embodiments are generally directed to a stack of such compartments.

Certain aspects are generally directed to apparatuses and methods for removing target ions, such as lithium, from a target ion-rich fluid (e.g., a feed solution), and transferring them to a target ion-poor fluid (e.g., a recovery solution), using various electrochemical ion exchange techniques. One example of such an apparatus is now described. The apparatus in this example may be used to extract lithium ions from a first fluid (for example, one having a relatively high concentration of lithium ions, i.e., a lithium-rich fluid), and add them to a second fluid (for example, one having a relatively low concentration of lithium ions, i.e., a lithium-poor fluid).

The first fluid may be, for example, a salt-lake brine, a subterranean brine, a geothermal brine, seawater, a leach liquor from hard-rock mining, a leachate from lithium-ion battery recycling, or other potential sources of lithium ions. Such fluids, in some embodiments, may also contain high concentrations of other co-ions (e.g., cations or positively charged ions) such as sodium, calcium, magnesium, potassium, or other competing ions, as well as high concentrations of counterions (e.g., anions or negatively charged ions) such as chloride, sulfate, hydroxide, or the like. The second fluid may be, for example, fresh water, naturally occurring water, desalinated water, distilled water, etc., which can then become concentrated in lithium ions (while not being as concentrated in other co-ions) as described in this example, e.g., for subsequent processing or use. Thus, lithium ions from the first fluid may become purified and/or concentrated within the second fluid. In addition, it should be understood that while this example describes the purification of lithium ions, this is for ease of presentation only, and that in other embodiments such as are described herein, other ions instead of lithium may be separated, for example, using various ion-selective electrodes such as those described herein.

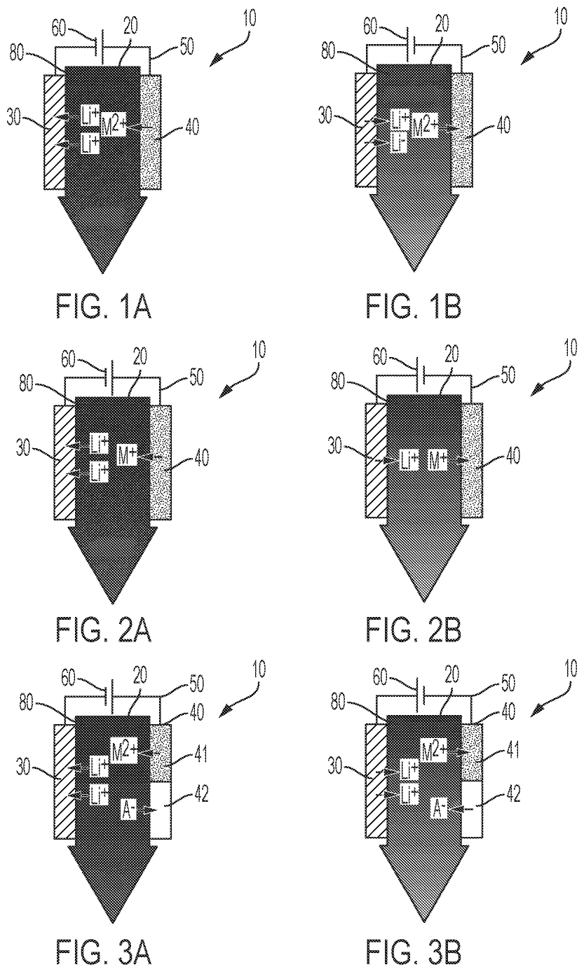

One non-limiting example of such an apparatus is now described with respect to FIG. 1. In FIG. 1A, apparatus 10 is shown with compartment 20, lithium-selective electrode 30, and multivalent cation-selective electrode 40. The electrodes may be connected, in some cases, by an electrical pathway 50, and a voltage source 60 may be used to drive current through the electrodes. A fluid 80 may be present within compartment 20, and in some cases, may flow through the compartment, e.g., as is shown in FIG. 1A.

Apparatuses such as these may be used in accordance with certain embodiments to remove lithium ions from a first fluid and add them to a second fluid. For example, at a first time, when a current is applied to the electrodes of such an apparatus, e.g., via a voltage source, at the lithium-selective electrode, lithium ions can act as charge carriers and are driven into the lithium-selective electrode, e.g., becoming incorporated into the electrode by combining with electrons (Li⁺+e⁻-->Li⁰). In addition, at the multivalent cation-selective electrode, cations can also act as charge carriers, and can be removed from the electrode when a current is applied (M⁰-->M²⁺+2⁻), e.g., entering the fluid within the compartment as ions. (It should be understood that the multivalent ions can also be trivalent or have higher valences, and divalent ions are described here by way of example only.) In summary, in this example, lithium ions are removed from the lithium-rich fluid and are exchanged for other multivalent ions as current is applied to the electrodes.

At a second point of time, however, the lithium may be removed from the lithium-selective electrode into a second fluid, e.g., a recovery solution or a lithium-poor fluid. The lithium-poor fluid may be one that has relatively low concentrations of lithium, including no lithium. For instance, in FIG. 1B, fluid 80 may be present within compartment 20, and current applied to electrodes 30 and 40. At the lithium-selective electrode, lithium is driven out as lithium ions (Li⁰-->Li⁺+e⁻), while at the multivalent cation-selective electrode, cations are driven into the electrode (M²⁺+2e⁻-->M⁰), by the application of a current. In this way, lithium ions are driven into the second fluid, e.g., by action of a current, in exchange for multivalent ions that are removed from it.

Thus, these electrically driven ion exchange processes, in combination, cause lithium ions to be removed from the first fluid (e.g., a lithium-rich fluid) into a second fluid (e.g., a lithium-poor fluid). This may allow for lithium to be extracted or purified from a fluid. It should be understood, however, that the present disclosure is not limited to only the exchange of lithium ions and multivalent cations (e.g., divalent cations). For example, in certain cases, ions other than lithium may be exchanged in some embodiments, for example, sodium or potassium ions. As another example, monovalent ions (e.g., other than lithium) may be exchanged with lithium ions, for example, as is shown in FIG. 2 using a monovalent cation-selective electrode. Thus, in this example, cations are removed from cation-selective electrode 40 in FIG. 2A (M⁰-->M⁺+e⁻), and are driven into cation-selective electrode 40 in FIG. 2B (M⁺+e⁻-->M⁰), while at lithium-selective electrode 30, the lithium reactions are similar to the ones previously discussed.

Also, more than two ions may be exchanged in certain embodiments. As a non-limiting example, in FIG. 3, lithium ions may be exchanged for both different cations (for example, multivalent cations) and anions (for example, chloride ions), e.g., using a cation-selective electrode (for the cations) and a non-selective electrode or an anion-selective electrode (for the anions). In this figure, electrode 40 may comprise a first multivalent cation-selective portion 41 and a second, non-selective portion 42. In the first portion, cations may be removed from the electrode at a first point of time when a current is applied (in FIG. 3A, M⁰-->M²⁺+2e⁻), and driven into the electrode at a second point of time (in FIG. 3B, M²⁺+2e⁻-->M⁰), while in the second portion, anions may be driven into the electrode at a first point of time and removed from the electrode at a second point of time.

Accordingly, it should be understood that the present disclosure is not limited to only the above-described apparatuses and methods for extracting lithium ions, and that other embodiments are also possible. For example, various aspects are also generally directed at various apparatuses and methods for extracting ions, e.g., using electrochemical ion exchange or other techniques that use electricity to drive ion exchange.

For example, certain aspects are generally directed to apparatuses and methods for driving ion exchange using electricity. In certain embodiments, two or more electrodes may be present in a compartment, connected by an electrical pathway. The compartment may be used to contain a fluid, e.g., containing ions. A voltage source may be used to drive current through the electrodes and the compartment. In the electrical pathway, the charge carriers may be electrons; however, in the fluid, the current may be carried by ions within the fluid. In addition, in some cases, a plurality of compartments may be used, e.g., forming a stack of compartments.

At the electrodes, electrochemical reactions may take place. For example, in the case of cation charge carriers, at one electrode, electrons may flow from an electrical pathway into the electrode and combine with cations to form a neutral material (e.g., a metal) which can become incorporated into the electrode, while at the other electrode, the material may become split into cations and electrons, and the cations may enter the fluid while the electrons move into the electrical pathway. In the case of anion charge carriers, at one electrode, electrons may flow from an electrical pathway into the electrode and bind to a neutral material to form an anion that can enter the fluid, while at the other electrode, the anion may incorporate into the electrode, releasing an electron that can enter the electrical pathway.

The two electrodes may be present in a common fluid within the compartment in some embodiments, e.g., without being separated by a membrane or a separator dividing the compartment into separate chambers. Thus, the two electrodes, in certain embodiments, may be in fluid communication with each other within the compartment.

In certain embodiments, however, only specific charge carriers can move from the fluid into the electrodes, or vice versa. For example, one or more of the electrodes may be an ion-selective electrode, e.g., an electrode that allows one (or a small number of) ions to enter or leave the electrode. As discussed herein, examples of such ion-selective electrodes may include lithium-selective electrodes, monovalent ion-selective electrodes, divalent cation-selective electrodes, multivalent cation-selective electrodes, or the like. These electrodes may be useful in controlling the types of ion exchange that occur when driving ion exchange using electricity.

For example, in one set of embodiments, a lithium-selective electrode may be used together with another electrode, for example, a divalent cation or other multivalent cation-selective electrode, another monovalent ion-selective electrodes that is not a lithium-selective electrode, an anion-selective electrode, a non-selective electrode, or the like. As discussed herein, such a combination of electrodes, including a lithium-selective electrode, may be used in certain cases to extract lithium from a fluid through ion exchange. For example, in certain embodiments, lithium may be incorporated from a first fluid (e.g., a lithium-rich fluid) into the lithium-selective electrode, and at a second point of time, the lithium may be removed from the lithium-selective electrode into a second fluid (e.g., a lithium-poor fluid), thereby causing the extraction of lithium from the first fluid into the second fluid.

In certain embodiments, incorporation of lithium or other target ions from a fluid in the compartment into an electrode (e.g., a lithium-selective electrode), and removal of lithium or other ions from the electrode into the compartment, may occur at two different times or phases of operation. Thus, at a first time, a first fluid (e.g., a feed solution) may be present within the compartment, and target ions from the first fluid can be incorporated from the fluid into a target ion-selective electrode, for example, by flowing current in a first direction through the compartment. As the target ion-selective electrode is selective to target ions, the ions incorporated into the electrode may be predominately target ions, as other ions may be inhibited from becoming incorporated into the electrode. In contrast, at a second time, a second fluid (e.g., a recovery solution) may be present within the compartment, and target ions from the target ion-selective electrode may be removed from the electrode into the second fluid, e.g., by flowing current in a second direction (opposite to the first direction) through the electrode. The first fluid and/or the second fluid may be introduced in various manners within the compartment, e.g., as batch operations, or via continuous flow in some cases (for example, as shown in FIGS. 1-3). In addition, in some cases, this process may be repeated one or more times, depending on the application, e.g., to extract target ions from the first fluid to the second fluid.

It should be understood that while many examples herein are described using lithium ions, the present disclosure herein is not so limited, and that in other aspects, other target ions instead of or in addition to lithium may be separated, e.g., using an apparatus as described herein. Examples of such target ions include sodium, potassium, copper, gold, silver, magnesium, calcium, nickel, manganese, cobalt, chloride, sulfate, nitrate, hydroxide, heavy metals, transition metals, rare earth elements, lanthanides, actinides, or other ions described below. In some cases, a suitable target ion-selective electrode may be used to allow for separation or extraction of such target ions, e.g., as discussed herein. Accordingly, more generally, various aspects as described herein are directed to various apparatuses and methods for the extraction of ions.

The apparatus may be used in one set of embodiments to purify a fluid rich in a target ion, such as a target cation or a target anion. As mentioned, in one set of embodiments, the target ion may be lithium. Examples of lithium-rich fluids in which it may be desired to extract the lithium include, but are not limited to, water from naturally occurring or artificially produced brines, for example, salt-lake brines, geothermal brines, artificial desalination brines, water from hydraulic fracturing, brackish water, underground water, or seawater. In some cases, such water may contain high concentrations of sodium, potassium, calcium, magnesium, and/or other competing ions which differ from the target ions. As another example, the lithium-rich fluid may be a leachate, such as an acidic or basic leachate or other leach liquor. The leachate may be a leachate from, for example, hard-rock mining, lithium metal recycling, lithium-ion battery recycling, or the like. Examples of hard rocks containing lithium include spodumene or eucryptite, which may be crushed and processed in some cases by hydrometallurgical methods to dissolve lithium and other ions in a leachate. Still other non-limiting examples include water produced from oil or gas extraction (e.g., water produced by hydraulic fracturing), nuclear plant cooling or cleaning water, reverse-osmosis or other desalination processes, or other water treatment processes.

However, as mentioned, in other embodiments, other target ions may be extracted, instead of or in addition to lithium. For example, the target ion may be a metal ion, e.g., another dissolved metal cation. Non-limiting examples include sodium, potassium, silver, gold, copper, iron, aluminum, mercury, cadmium, chromium, arsenic, manganese, cobalt, nickel, other transition metals, lanthanum, ytterbium, cerium, neodymium and other lanthanides, yttrium, actinium, thorium, uranium, plutonium, and other actinides, etc. In certain cases, the target ion may be an anion, such as chloride, sulfate, nitrate, or hydroxide, or ionic complexes of the metal cations listed above, such as heavy metal oxyanions (e.g., arsenate, chromate, ferricyanide, etc.) or the like, which can be extracted using a suitable electrode selective to the target ion, as discussed herein. In some cases, more than one target ion can be extracted in an apparatus, for example, by using a first electrode within a compartment that is selective to a first target ion, and a second electrode within the compartment that is selective to a second target ion, thereby allowing the different target ions to be incorporated (e.g., deposited, intercalated, etc.) into and/or removed from the different electrodes.

In some cases, the target ion may be dissolved in an aqueous solution. For example, the aqueous solution may be seawater, brackish water, underground water, geothermal water, brines, leachates from mining operations, water produced from oil or gas extraction, or the like, including any of the sources of water previously described above. As a non-limiting example, in one set of embodiments, the first fluid rich in the target ion may be obtained by passing water or aqueous solutions across ores or rocks rich in one or more target ions, which may allow such ions to leach out of the ores or rocks. As another example, the water or aqueous solution may be obtained by passing water or aqueous solution across electrical components (e.g., semiconductor chips) to leach out such ions. As other examples, the water or aqueous solution may be obtained as a leachate from metal scrap, e-waste, or battery recycling, etc. In certain cases, such processes may be facilitated by elevating or lowering the temperature, mechanical operations (crushing, grinding, shredding, pulverizing, etc.), or the like.

In some embodiments, the target ion may be dissolved in a non-aqueous solution. As a non-limiting example, in one set of embodiments, the target ion is lithium, and the first fluid rich in the target ion is a Li-ion battery electrolyte, containing an organic solvent, such as ethylene carbonate, ethyl-methyl or di-methyl carbonate, a dissolved lithium salt as well as possible contaminants. In some embodiments, the organic Li-ion battery electrolyte is obtained from aged Li-ion batteries, and lithium extraction may be performed during battery recycling.

In certain embodiments, the lithium (or other target ions) may be present in the fluid at a concentration of at least 0.01 mol %, at least 0.02 mol %, at least 0.03 mol %, at least 0.05 mol %, at least 0.1 mol %, at least 0.2 mol %, at least 0.3 mol %, at least 0.5 mol %, at least 1 mol %, at least 2 mol %, at least 3 mol %, at least 5 mol %, at least 10 mol %, etc. of the target ion. Other concentrations are also possible in other embodiments. In some cases, the concentration of lithium (or other target ions) may not be known.

In one set of embodiments, the target ions (for example, lithium, copper, gold, silver, chloride, hydroxide, etc. etc.) may be extracted into a second or recovery fluid, e.g., one that is free of the target ion, or at least one that is relatively poor or has a lower concentration of the target ion than the fluid rich in a target ion.

As a non-limiting example, for lithium ion extraction, the second fluid may be a lithium-poor fluid, e.g., one that has a relatively low concentration of lithium ions (or is substantially free of lithium ions). For example, the lithium-poor fluid may have a concentration of lithium of no more than 0.1 mol %, no more than 0.05 mol %, no more than 0.01 mol %, etc. Non-limiting examples of such fluids include fresh water (e.g., naturally-occurring fresh water), purified water, distilled water, desalinated water, municipal water, or the like. Other examples of lithium-poor fluids include groundwater, brackish water, partially treated seawater, etc. In some embodiments, the recovery solution may contain relatively low concentrations of other ions. For example, the recovery solution may contain less than 10 g/L, less than 5 g/L, less than 3 g/L, less than 1 g/L, less than 0.5 g/L, less than 0.3 or less than 0.1 g/L, less than 0.05 g/L, less than 0.03 g/L, or less than 0.01 g/L of one or more contamination ions such as sodium, potassium, etc. Other examples of contaminating ions include calcium, magnesium, iron, silicon, or boron.

The second (or recovery) fluid can then be used for a variety of applications, e.g., using the extracted lithium, or other target ion. The second fluid may have a concentration of the target ion of no more than 0.1 mol %, no more than 0.05 mol %, no more than 0.01 mol %, etc. In some cases, e.g., for lithium, the lithium may be available within the second fluid as a lithium hydroxide solution, a lithium chloride solution, a lithium carbonate solution, or the like. In some embodiments, the second fluid can be directly used as a source of lithium for the direct manufacture of lithium batteries, e.g., without requiring subsequent processing, purification, crystallization, or the like. However, in other cases, the second fluid may be processed, for example, using subsequent steps such as reverse osmosis, evaporation, precipitation, or the like to concentrate the lithium or other target ions.

In certain aspects, an apparatus as discussed herein can include one or more compartments, which can contain a fluid. In some cases, fluids can flow into and/or out of the compartments. The compartment can be formed using metals, plastics, ceramics, or other suitable materials. In some cases, a compartment may be lined or coated with a plastic, e.g., a substantially water-resistant plastic, a hydrophobic plastic, or the like. The compartment may in some embodiments also be filled with and/or supported by a porous plastic or other permeable material, e.g., which may promote mixing by hydrodynamic dispersion during ion extraction.

The compartment may be of any size. For example, a compartment may have a volume of at least 0.1 m³, at least 0.3 m³, at least 0.5 m³, at least 1 m³, at least 3 m³, at least 5 m³, at least 10 m³, etc. The compartment may also have any suitable shape, including cylindrical or rectangular. However, it should be understood that in some embodiments, non-rectangular stacks or non-rectangular compartments may be used. For instance, there may be a stack of compartments, where the stack may be cylindrical, for example, with inward or outward radial flow between parallel circular annular electrodes and membranes (or other separators). Such a configuration may be useful, for example, for reducing mixing by hydrodynamic dispersion during ion exchange. In some embodiments, the stack is rolled or has spiral-wound cylindrical shape, optionally with either normal or parallel flow through the electrodes, e.g., as described herein. Flows in such cylindrical stacks may be radially and/or axially directed in some embodiments. In some embodiments, a rectangular or non-rectangular stack may be oriented vertically with lighter fluids introduced above heavier fluids, for example, in order to reduce mixing by buoyancy-driven convection.

A compartment may be open or closed in some embodiments. In some cases, gaskets or spacers may be present. In some embodiments, the compartment may contain inert or porous materials, for example, glass fabrics or mats (e.g., coated with PTFE), electrospun or extruded fibrous polymeric materials, packed beds of beads (e.g., glass, ceramic, plastic, etc.), or the like. If the compartment is one that allows fluid flow through the compartment, the flow of fluid may be in any suitable orientation, e.g., vertical, horizontal, etc. As an example, some or all of the compartments in a stack may be oriented vertically in one embodiment, e.g., to allow precipitates to fall through the compartments, e.g., for collection.

In some cases, a compartment (e.g., including electrodes, etc.) may define a “repeat unit” that is repeated throughout the entire stack, in which some or all of the repeat units are nearly identical. There may be any number of repeat units within the stack. For instance, a stack may contain at least 2, at least 4, at least 5, at least 10, at least 15, at least 20, at least 25, at least 30, at least 40, at least 50, at least 60, at least 75, at least 100, etc. repeat units. In addition, the repeat units may extend in two dimensions, or three dimensions in some cases. For example, a stack may comprise a plurality of repeat units that extend in two dimensions. In some cases, the repeat units at the ends of a stack may be different than the internal repeat units, for example, ending with different electrodes or flow channel geometries. Thus, certain embodiments are generally directed to an apparatus that includes a plurality or “stack” of compartments, e.g., as discussed herein.

In some cases, a fluid may completely fill the compartments, and/or only a portion of a compartment may be filled with fluid. For example, in some cases, at least 10%, at least 20%, at least 30%, at least 40%, at least 50%, at least 60%, at least 70%, at least 80%, or at least 90% (by volume) of a compartment may be filled with a fluid.

Some or all of the compartments in an apparatus may also contain one, two, or more electrodes, such as a lithium-selective electrode, or other electrodes including those described herein, in accordance with various aspects. In addition, in some embodiments such as described in more detail below, the electrode may be porous, e.g., comprising particles, fibers, or the like to cause porosity, which may allow fluid to flow through the electrode in some cases. For example, the electrode may be porous, e.g., formed from a porous conducting material such as discussed herein.

Each of the compartments may independently have the same or different electrodes therein. In addition, in some cases, for instance, all of the electrodes within a stack are compositionally identical other than the presence/absence of any deposited, electrosorbed, or intercalated lithium (or other target ions).

In addition, certain electrodes within a set of compartments may be connected to each other. For example, a first set of lithium-selective electrodes (and/or other electrodes) may be connected to each other, and/or a second set of non-lithium ion selective electrodes (and/or other electrodes) may be connected to each other, and the sets of electrodes may be connected, e.g., via an electrical pathway.

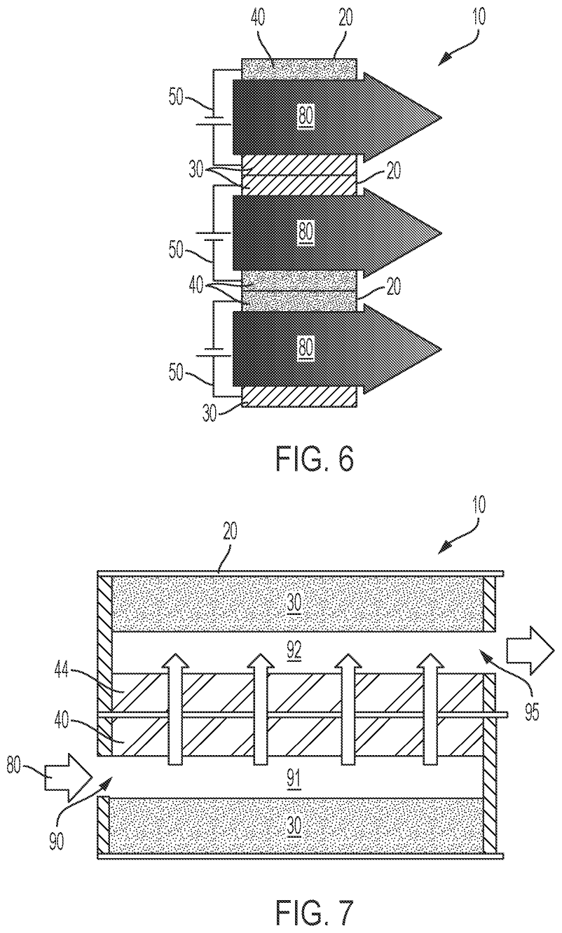

One non-limiting example of such a stack is shown in FIG. 6. In this figure, apparatus 10 has 3 compartments 20, each of which contains a lithium-selective electrode 30 and a cation-selective electrode 40. In each compartment, fluid 80 flows from left to right, and ions can be exchanged with the selective electrodes, e.g., as discussed herein.

In this example, the electrodes of adjacent compartments are of the same type of selectivity, thus resulting in a stack of “mirror image” compartments. However, it should be understood that although in some embodiments, repeat units within an apparatus may be arranged in a mirror image alternating manner (e.g., as shown in FIG. 6), in other embodiments, other arrangements may also be used.

In an aspect, the compartments may include one or more ion-selective electrodes. These may include cation-selective electrodes or anion-selective electrodes, or anion-capture electrodes in some embodiments. As discussed herein, a variety of ion-selective electrodes may be used in various embodiments. A compartment may contain one, two, or more types of ion-selective electrodes. In addition, in some embodiments, a compartment may contain any number of the same type of electrode, e.g., 1, 2, 3, 4, or more first electrodes, and/or 1, 2, 3, 4, or more second electrodes, etc. For example, the electrodes may include one or more of a first type of electrode and/or one or more of a second type of electrode, or there may be three or more different types of electrodes present in a compartment, in various embodiments.

Non-limiting examples include sodium ion-selective electrodes or potassium ion-selective electrodes, or other alkali ion-selective electrodes, such as rubidium ion-selective electrodes, cesium ion-selective electrodes, francium ion-selective electrodes, etc. Thus, in one embodiment, an active material may comprise a sodium-ion intercalation material. Non-limiting examples of sodium-ion intercalation materials include sodium manganese oxide (NMO), sodium vanadium oxide (NVO), sodium iron phosphate (NFP), sodium titanium phosphate (NTP), Prussian blue analogues (PBA), Prussian white analogues (PWA), carbon nanomaterials, or the like. In one embodiment, an active material may comprise a potassium-ion intercalation material. Non-limiting examples of potassium-ion intercalation materials include potassium manganese oxide (KMO), potassium vanadium oxide (KVO), potassium iron phosphate (KFP), potassium vanadium phosphate (KVP), PBA, PWA, graphite, or the like.

Non-limiting examples of sodium or potassium selective intercalation electrode materials include Prussian blue (Fe₄[Fe(CN)₆]₃), Prussian blue analogues, Prussian white (Na₂Fe₂(CN)₆), Prussian white analogues (e.g., nickel hexacyanoferrate, Na₂NiFe(CN)₆, manganese hexanoferrate (Na₂MnFe(CN)₆,), etc. Non-limiting examples of sodium-ion intercalation materials include sodium manganese oxide (NMO), sodium vanadium oxide (NVO), sodium iron phosphate (NFP), sodium titanium phosphate (NTP), Prussian blue analogues (PBA), Prussian white analogues (PWA), carbon nanomaterials, or the like. In one embodiment, an active material may comprise a potassium-ion intercalation material. Non-limiting examples of potassium-ion intercalation materials include potassium manganese oxide (KMO), potassium vanadium oxide (KVO), potassium iron phosphate (KFP), potassium vanadium phosphate (KVP), PBA, PWA, graphite, or the like. In another set of examples, the target ions are rare earth elements, such as lanthanides and actinides, which may be extracted by selective intercalation, for example, by metal hexanoferrates, Prussian blue or white analogues, other metal-organic framework (MOF) electrodes, or the like. In some cases, rare elements may be separated by size, for example, as the smaller, heavier ions may be intercalated more easily. Non-limiting examples of target ions may include metal lanthanides, such as lanthanum, cerium, neodymium, gadolinium, terbium, europium, etc., or metal actinides, such as uranium, plutonium, thorium, etc.

As a non-limiting example, a compartment may contain a lithium-selective electrode an ion-selective electrode that is not a lithium-selective electrode, such as a monovalent ion-selective electrode, a divalent cation-selective electrode, a multivalent cation-selective electrode, an anion-selective electrode, etc., e.g., as discussed herein. As another example, a compartment may contain a sodium-selective electrode, an ion-selective electrode that is not a sodium-selective electrode, such as a monovalent ion-selective electrode, a divalent cation-selective electrodes, a multivalent cation-selective electrodes, etc. Accordingly, certain embodiments are generally directed to a target ion-selective electrode, an ion-selective electrode that is not a target ion electrode, e.g., for various target ions such as copper, gold, silver, magnesium, calcium, nickel, manganese, cobalt, chloride, sulfate, nitrate, hydroxide, heavy metals, and others including any of those disclosed herein.

One non-limiting example of a compartment with more than 2 electrodes is shown in FIG. 5. In this figure, in apparatus 10, compartment 20 contains 3 lithium-selective flow-through electrodes 30 and 3 cation-selective flow-through electrodes 40. Fluid 80 flows through compartment 20 from left to right, passing through each of these flow-through electrodes. The electrodes are connected together by electrical pathways 50, allowing electrically-driven ion exchange to occur as fluid 80 passes through the compartment 20.

In certain aspects, lithium-selective electrodes may be used. As discussed, the lithium-selective electrodes may preferentially allow lithium to be incorporated (e.g., deposited, intercalated, etc.) or removed therefrom, relative to other co-ions (e.g., cations or positively charged ions) such as sodium, calcium, magnesium, or other competing ions. The lithium-selective electrode may comprise an active material such as an active battery cathode material. The active material, in one set of embodiments, can be a material that is selective for reaction with lithium ions versus other competing co-ions. Thus, for example, the active material may be a material that preferentially reacts with lithium ions in solution, e.g., such that the lithium ions can be incorporated into the electrode due to such reaction. Non-limiting examples of materials that may be used in the lithium-selective electrode include lithium iron phosphate, lithium titanium phosphate, lithium manganese oxide, or other materials such as those described herein. The incorporation may occur by ion intercalation, electrosorption, electrodeposition, or the like, as well as combinations of these and/or other processes in certain embodiments. In some cases, this reaction may be reversible, e.g., such that the incorporated lithium can be released from the active material to enter solution as lithium ions.

In some cases, the active material may be material that forms a lithium salt, reduced lithium metal, and/or a material that intercalates lithium ions as compensating electrons reduce the host material. The active material may be, for example, a lithium-ion battery active material, such as a lithium-ion intercalation material. In addition, in some cases, more than one such active material may be present, including any one or more of the active materials described herein, and/or other active materials.

For instance, in one embodiment, the active material may comprise a lithium metal phosphate, LiMePO₄, where Me can be a transition metal such as iron (e.g., lithium iron phosphate, LiFePO₄ or LFP), titanium (e.g., lithium titanium phosphate, LiTi₂(PO₄)₃ or LTP), manganese, nickel, cobalt, or the like, or a mixture of transition metals such as manganese, iron, cobalt, nickel, etc. (e.g. lithium manganese iron phosphate, LiMnₓFe₁₋ₓPO₄ or LMFP). In some cases, more than one such metal may be present, including these and/or other suitable metals. For example, the active material may include a blend of LTP and LFP, a composition comprising lithium iron titanium phosphate, other blends, or the like. In some embodiments, smaller quantities of metals, for example, transition metals such as manganese or nickel, may be present, e.g., within the active material, e.g., lithium manganese nickel phosphate, LiFe_{1-x-y}MnₓNi_{y}PO₄, where x and y are each independently less than 1.

In some cases, the active material may include a lithium transition-metal oxide, LiMeO₂, where Me can be a transition metal. Non-limiting examples include manganese (e.g., lithium manganese oxide, LiMnO₂ or LMO), nickel (e.g., lithium nickel oxide, LiNiO₂ or LNO), cobalt (e.g., lithium cobalt oxide, LiCoO₂ or LCO), or the like. More than one transition metal may be present in some embodiments, e.g., as combinations or stochiometric blends. As non-limiting examples, the active material may include a combination of LiMnO₂ and LiNiO₂, or a composition comprising Li(MnₓNi₁₋ₓ)O₂, or the like.

In another example, the active material may include lithium titanate, Li₂TiO3 and/or Li₄Ti₅O₁₂ (LTO), optionally with coatings such as LiTiO₂, or other coatings such as any of those described herein. Still other non-limiting examples of lithium-ion intercalation material include nickel manganese cobalt oxide (NMC) or nickel cobalt aluminum oxide (NCA).

In yet another example, the active material may be a solid metal. Examples include, but are not limited to, lithium metal, which may be coated with a lithium-selective solid electrolyte membrane material, such as a lithium superionic conductor (LISICON). In some embodiments, in order to avoid chemical reduction of Ti(IV) in LISICON or other degradation phenomena in contact with the aqueous brine, a buffer coating such as lithium phosphorous oxynitride (LiPON) may also be applied. Other non-limiting examples of membrane materials include lithium aluminum titanium phosphate, lithium superionic conductors, LiPON, lithium lanthanum zirconium oxide, solid polymer electrolytes, etc.

In still another example, active material may comprise a lithium-ion intercalation material. Non-limiting examples of lithium-ion intercalation material comprises lithium titanium phosphate (LTP), lithium manganese oxide (LMO), nickel manganese cobalt oxide (NMC), nickel cobalt aluminum oxide (NCA), lithium cobalt oxide (LCO), lithium iron phosphate (LFP), lithium manganese iron phosphate (LMFP), lithium titanium oxide (LTO), disordered rock salt (DRX), graphite, graphene oxide, hard carbon, a carbon ionomer composite, functionalized carbon, or the like.

However, in one set of embodiments, electrodes selective to other target ions (e.g., cations other than lithium ions, for example, sodium, potassium, hydrogen, or the like) may be used, e.g., if the target ion to be extracted is not lithium. In some embodiments, the electrodes may include active materials, such as Prussian blue (Fe₄[Fe(CN)₆]₃), Prussian blue analogues (e.g., nickel hexacyanoferrate, Ni₂FE(CN)₆), sodium manganese oxide (Na₂Mn₅O₁₀), titanium disulfide (TiS₂), sodium chromium oxide, sodium cobalt oxide, sodium manganese oxide, sodium cobalt phosphate, sodium nickel phosphate, sodium iron phosphate, potassium cobalt oxide, potassium manganese oxide, potassium iron phosphate, potassium vanadium oxide, potassium vanadium phosphate, Prussian white (e.g., potassium Prussian white or KPW), Prussian white analogs (e.g., nickel hexacyanoferrate, Na₂NiFe(CN)₆, manganese hexanoferrate (Na₂MnFe(CN)₆), etc. may be used to selectively intercalate sodium or potassium, etc. In another set of embodiments, the electrodes may be selective to multivalent target ions, such as Mg²⁺ or Ca²⁺, versus monovalent ions, such as Na⁺, Li⁺, and K⁺, e.g., by virtue of a high chemical surface charge in a microporous metallic electrode. Non-limiting examples of such multivalent-ion-selective electrodes include sulfonated porous carbons, vanadium oxide, Prussian Blue analogues, molybdenum sulfides, molybdenum oxides, manganese oxides, manganese/iron/cobalt silicates, vanadium phosphates, Mg metal, Ca metal, Mg/Ca alloys, etc. In some cases, one or more of these materials may be present, e.g., as an intercalant. In yet another embodiment, the active material may comprise a metal oxide, a metal phosphate, a metal-organic framework, a conjugated polymer, and/or a carbonaceous material, etc.

In one set of embodiments, the active material may be present in an electrode at at least 1 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, etc. In some case, the active material may be present at no more than 95 wt %, no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 1 wt %, etc. Combinations of any of these are also possible. For example, an active material may be present at a concentration of between 70 wt % and 90 wt %, between 30 wt % and 50 wt %, between 20 wt % and 45 wt %, etc.

In certain embodiments, an active material may be present in the electrode at at least 1 mg/cm² of surface. In some cases, the active material may be present at at least 2 mg/cm², at least 3 mg/cm², at least 5 mg/cm², at least 10 mg/cm², at least 15 mg/cm², at least 20 mg/cm², at least 25 mg/cm², at least 30 mg/cm², at least 35 mg/cm², at least 40 mg/cm², at least 45 mg/cm², at least 50 mg/cm², at least 55 mg/cm², at least 60 mg/cm², at least 65 mg/cm², at least 70 mg/cm², at least 75 mg/cm², at least 80 mg/cm², at least 85 mg/cm², at least 90 mg/cm², at least 100 mg/cm², at least 110 mg/cm², at least 120 mg/cm², at least 150 mg/cm², at least 200 mg/cm², etc. In some cases, the active material may be present at no more than 200 mg/cm², no more than 150 mg/cm², no more than 120 mg/cm², no more than 110 mg/cm², no more than 100 mg/cm², no more than 90 mg/cm², no more than 85 mg/cm², no more than 80 mg/cm², no more than 75 mg/cm², no more than 70 mg/cm², no more than 65 mg/cm², no more than 60 mg/cm², no more than 55 mg/cm², no more than 50 mg/cm², no more than 45 mg/cm², no more than 40 mg/cm², no more than 35 mg/cm², no more than 30 mg/cm², no more than 25 mg/cm², no more than 20 mg/cm², no more than 15 mg/cm², no more than 10 mg/cm², no more than 5 mg/cm², no more than 3 mg/cm², no more than 2 mg/cm², no more than 1 mg/cm², etc. In addition, combinations of any of these ranges are also possible.

In some cases, an active material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the active material or other component may have a contact angle of between 75° and 90°, between 70° and 100°, between 80° and 100°, etc.

In addition, in certain aspects, the compartments may include one or more divalent or other multivalent cation-selective electrodes. Examples of divalent ions (+2 charge) include Ca²⁺, Mg²⁺, Ni²⁺, Co²⁺, Zn²⁺, Cu²⁺, Mn²⁺, certain lanthanides or actinides, or the like. However, other, higher charges are also possible, e.g., +3 charged ions such as Fe³⁺, Al³⁺, Co³⁺, certain lanthanides or actinides, or the like. Specific non-limiting examples of multivalent cation-selective electrodes include, but are not limited to, Mg-selective electrodes, Mn-selective electrodes, Ni-selective electrodes, or the like. In some cases, such ion-selective electrodes can be made in similar fashion as a lithium-selective electrode, such as discussed herein. In some embodiments, the ion-selective electrode may be a divalent or other multivalent selective electrode. The divalent or other multivalent selective electrode may be relatively selective only against monovalent ions. This can be achieved, for example, by functionalizing an electrode to make the surface charge relatively dense and negatively charged, e.g., so as to induce a preference of more positively charged ions over less positively charged ions.

In some cases, the cation-selective electrode is a carbon-based electrode. For example, the carbon-based electrode may be formed from carbon-based materials such as activated carbon, carbon nanotubes, graphene, carbon aerogel, graphitic carbon, carbon black, graphene oxide, Vulcan carbon, coke, carbon nanotubes, or the like. In some cases, the electrode may be porous, e.g., formed from a porous conducting material such as discussed herein. Fluid may also flow around and/or through the electrodes (e.g., using flow-through electrodes).

In certain embodiments, the cation-selective electrode may be functionalized to enhance cation-selectivity. In some cases, a surface may be functionalized using functionalization agents, which can react with a surface to form surface groups. For example, the electrode may be enhanced with surface groups such as carboxylic acids, sulfonic acids, phosphoric acids, or the like. In some cases, the cation-selective electrode may be pre-charged in situ or ex situ.

In addition, in certain cases, an electrode may comprise various portions with different selectivities. For example, an electrode may comprise a first portion and a second portion, where the first portion is functionalized, e.g., as discussed herein, while the second portion is not functionalized, or functionalized with a different functionality. For instance, the first portion may be functionalized to be a divalent or other multivalent cation-selective electrode, while the second portion may not be selective to ions, and/or may be functionalized to be selective to different ions than the first portion. In some cases, for example, the second portion may be non-selective. In certain embodiments, the second electrode may be acting as a more general cation electrode or anion electrode. In addition, the first portion and the second portion may be in physical contact with each other, or separate in some cases.

In one embodiment, as a non-limiting example, an electrode may be functionalized to enhance divalent or other multivalent cation selectivity with surface groups for some fraction of the electrode area, while the remaining fraction of the electrode is not functionalized and remains largely non-selective. Such segmentation can be within a single contiguous electrode, between material layers forming the electrode, or between separate electrodes placed in the same compartment, or adjacent compartments, or the like.

In addition, in accordance with certain aspects, electrodes such as any of those discussed herein, including lithium-selective electrodes, and/or divalent or other multivalent cation-selective electrodes, may independently have any shape or size, and the electrodes within different compartments may independently have the same or different shapes or sizes. For example, an electrode may be rectangular, cylindrical, toroidal, or spherical, or have other shapes (including regular or irregular shapes). In some cases, the electrode may have a longest dimension that is at least 10 mm, at least 20 mm, at least 30 mm, at least 50 mm, at least 100 mm, at least 200 mm, at least 300 mm, at least 500 mm, at least 1000 mm, etc. In some embodiments, the electrode may have a longest dimension that is no more than 1000 mm, no more than 500 mm, no more than 300 mm, no more than 200 mm, no more than 100 mm, no more than 50 mm, no more than 30 mm, no more than 20 mm, no more than 10 mm, no more than 5 mm, no more than 3 mm, no more than 2 mm, no more than 1 mm, etc. Combinations of any of these ranges are also possible in yet other embodiments. For example, the electrode may have a longest dimension that is between 300 mm and 500 mm, between 500 mm and 1000 mm, between 10 mm and 50 mm, etc.

A compartment may have only a single electrode, or more than one electrode in some cases. If more than one electrode is present, the electrodes may independently have the same or different sizes, shapes, compositions, etc. In addition, as discussed herein, some or all of the compartments within a stack may independently contain one or more electrodes, which may independently have the same or different sizes, shapes, compositions, etc. As an example, in some embodiments, at least 50%, at least 75%, at least 80%, or at least 90% of the electrodes within a stack may be compositionally identical, other than the presence/absence of any incorporated lithium. In some cases, the electrodes within a stack may be connected via electrical pathways in any suitable arrangement, e.g., in any suitable configuration, e.g., in series, in parallel, or in other arrangements. Different groups of electrodes may be present within a stack in some embodiments (e.g., a first group and a second group of electrodes), and the electrodes within a group may independently be connected to each other in the same or different configurations, e.g., in series, in parallel, or in other configurations.

In one set of embodiments, the electrode may comprise a coating. The coating may, in some embodiments, partially or completely surrounded an active material, and/or active material may be present in the coating, for example, as a component of the coating. One or more than one coating may be present in some cases. However, it should also be understood that no coating may be present in certain instances. The coating may provide a variety of functions, depending on the embodiment. In some cases, a coating may be used to enhance wettability, increase ionic or electronic conductivity, improve electrochemical stability or the like. For example, in one embodiment, a coating may include a lithium-selective material, which may provide additional lithium selectivity versus competing co-ions, such as sodium. Other ion-selective (e.g., cation-selective) materials can also be used in certain embodiments, e.g., for target ions other than lithium. As another example, a coating may include a hydrophilic coating, which may improve wettability of the electrode. In other embodiments, the coating may include a lyotropic ion, for example, to control fouling, wettability, precipitation, macromolecular interactions.

Non-limiting examples of coating materials include lithium titanium oxide (LiTiO₂) or polydopamine. Additional non-limited examples of coating materials include carbon (for example, graphitic carbon, carbon black, graphene oxide, Vulcan carbon, coke, carbon nanotubes, or the like), or conducting polymers (for example, polypyrrole (PPy), polyethylene oxide (PEO), or the like). Still another example includes ceramics. For example, a coating material may include one or more oxides of aluminum (i.e., alumina), silicon, zirconium (i.e., zirconia), niobium, etc. Other examples of ceramics include titania or phosphate or borosilicate glass. Such coating materials, in certain cases, may slow or block the transfer of electrons, metal ions, and/or oxygen.

The coating, if present, may be of any thickness on the electrode. For instance, the coating may have an average thickness on the electrode of at least 0.1 mm, at least 0.2 mm, at least 0.3 mm, at least 0.5 mm, at least 1 mm, at least 2 mm, at least 3 mm, at least 5 mm, at least 10 mm, at least 20 mm, at least 30 mm, at least 50 mm, at least 100 mm, etc. In addition, the coating may cover all, or a portion, of the electrode. For example, in various embodiments, the coating may cover at least 10%, at least 20%, at least 30%, at least 40%, at least 50%, at least 60%, at least 70%, at least 80%, at least 90%, at least 95%, etc. of the electrode.

The electrodes may be porous in one set of embodiments, e.g., formed from a porous conducting material. For example, an electrode may have a porosity that allows a liquid to enter, and/or pass through the pores, for example, in a normal or transverse direction to the current. The porosity may thus allow a liquid to enter the electrodes, thus allowing ions to incorporate and/or be removed from the electrodes, e.g., due to the increased available surface area. For example, the porosity may allow fast mass transfer of ions deep into the electrode materials.

In some cases, an electrode may have a porosity of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, and/or no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, no more than 5%, etc., as determined as a volume fraction of the material forming the electrode. For instance, an electrode may have a porosity of between 20% and 80%, between 20% and 25%, between 10% and 30%, between 35% and 45%, between 30% and 40%, between 25% and 70%, etc., on a volumetric basis. In addition, in some cases, the pores may have an average cross-sectional dimension of less than 1 mm, less than 300 micrometers, less than 100 micrometers, less than 30 micrometers, less than 10 micrometers, less than 3 micrometers, less than 1 micrometer, less than 300 nm, less than 100 nm, less than 30 nm, or less than 10 nm, etc. Porosity can be determined using standard porosimetry techniques (e.g., mercury intrusion porosimetry, cyclic porosimetry, gas absorption techniques, etc.) known to those of ordinary skill in the art.

The porosity within the electrodes may have a variety of configurations. For instance, an electrode may include one or more channels (e.g., “flow-through” channels), through which a fluid can flow through the electrode. See, e.g., U.S. Pat. Apl. Ser. No. 63/513,538, filed Jul. 13, 2023, entitled “Flow Systems and Methods for Membraneless Separation,” incorporated herein by reference in its entirety. As additional examples, an electrode may be fabricated from particles, fibers (which may be woven or non-woven), and/or other materials, e.g., packed into an electrode. For example, particles or fibers of active material (e.g., as discussed herein), inert materials, conducting materials, etc. may be packed together to form an electrode. Due to the shape of the particles, fibers, or other materials, spaces or pores may exist within the electrode, through which a fluid can flow.

Examples of inert materials include, but are not limited to, glass (e.g., phosphate glass), plastics, ceramics, or the like.

In some cases, an electrode may be formed using one or more porogens, which may increase the porosity of the electrodes. In some cases, the porogens can be removed, thereby increasing the porosity of the electrode. For example, an electrode may be fabricated using a porogen such as polythelyene glycol (PEG), for example, PEG-6000. Other examples of porogens include, but are not limited to, sucrose, ammonium carbonate, sodium chloride or other salts, or the like. Still other examples of porogens include chloride salts, sulfate salts, silica, carbonate salts, polystyrene, polyethylene glycol (PEG), polyvinyl pyrrolidone (PVP), polyvinylalcohol (PVA), polymethaacrylate (PMA), polyacrylicacid (PAA), or the like. Porogens can be subsequently removed, e.g., by heating the electrode to oxidize the porogen, or by adding water to dissolve the porogen. Other methods of introducing porosity into an electrode include laser ablation, additive manufacturing, mechanical patterning, or the like.

A non-limiting example of an embodiment containing flow-through electrodes is shown in FIG. 7. In this figure, in apparatus 10 compartment 20 contains two lithium-selective electrodes 30, a cation-selective electrode 40, and a non-selective electrode 44. Cation-selective electrode 40 and non-selective electrode 44 are both flow-through electrodes, which allows a fluid 80 to flow through compartment 20 from inlet 90, into first compartment 91, through the electrodes into second compartment 92, and then to outlet 95. Although this example does not show a flow-through lithium-selective electrode, it should be understood that this example is not limiting, and in other embodiments, a lithium-selective electrode (or another electrode) may be a flow-through electrode, and/or the other electrodes need not be flow-through electrodes.

In one set of embodiments, the electrode may include an additive, such as a conductivity additive, which can be used to increase conductivity of the electrode. Non-limiting examples of additives include carbon (for example, graphitic carbon, carbon black, graphene oxide, Vulcan carbon, coke, or the like), metals (for example, gold, silver, copper, or the like), etc. In addition, in some embodiments, more than one additive may be present in an electrode.

Examples of conducting materials include but are not limited to, carbon particles, e.g., coke particles, carbon black, Vulcan carbon particles, or the like. In one set of embodiments, the conducting material may include a capacitive material. Non-limiting examples of conductive materials include graphite, titanium, activated carbon, sulfonated carbon, or the like. As another example, the conducting material may include a metal (for example, present as a metal powder). Non-limiting examples include titanium, platinum, silver, zirconium, tin, copper, gold, zinc, stainless steel. As yet another example, the conducting material includes glass microspheres, for example, metal coated glass microspheres (such as the metals described herein). In still another example, a conductive material may include a conductive carbon material. Non-limiting examples include carbon black, carbon nanotubes, graphene, graphene oxide, etc. Yet other examples include a conductive polymer. Non-limiting examples of conductive polymers include poly(3,4-ethylenedioxythiophene) polystyrene sulfonate (PEDOT:PSS), polypyrrole, polythiophene, polyaniline (PANI), polythiophene, etc. Still other examples of conducting materials include conductive ceramic. Non-limiting examples of conductive ceramics include indium tin oxide (ITO), niobium titanium oxide (NTO), or the like. In addition, one or more than one conductive material may be present, including any of the conductive materials described herein.

In one set of embodiments, a conducting material may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the conducting material may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a conducting material may be present at a concentration of between 5 wt % and 80 wt %, between 30 wt % and 50 wt %, between 20 wt % and 45 wt %, etc.

In some cases, a conducting material may exhibit a contact angle of at least 60°, at least 70°, at least 75°, at least 80°, at least 85°, at least 90°, at least 95°, at least 100°, at least 105°, at least 110°, at least 115°, at least 120°, etc. In some cases, the electrode or other component may exhibit a contact angle of no more than 140°, no more than 135°, no more than 130°, no more than 125°, no more than 120°, no more than 115°, no more than 110°, no more than 105°, no more than 100°, etc. In some cases, the contact angle may be a combination of any of these. For example, the electrode or other component may have a contact angle of between 90° and 125°, between 85° and 120°, between 80° and 100°, etc.

In some embodiments, the electrode may include an ionically conductive additive. In some embodiments, this may improve the transport of ions through the electrode. In some embodiments, the ionically conductive additive may include perfluorinated hydrocarbon polymers linked to sulfonate groups (trademark name Nafion, Aquivion, etc.), alkali metal salts of polystyrene sulfonate, alkali metal salts of sulfonated poly(ether-etherketone) (SPEEK), alkali metal salts of polyvinylsulfonate, hydrocarbon polymers bearing peralkylated ammonium groups, hydrocarbon polymers bearing peralkylated phosphonium groups, or the like.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In some embodiments the electrode may include a mixed ion-electron conducting (MIEC) additive. In some embodiments, this may improve the transport of both ions and electrons through the electrode. Examples of MIEC additives include, but are not limited to, poly(3,4-ethylenedioxythiophene) polystyrene sulfonate (PEDOT:PSS), or polystyrene sulfonate (cation conducting) with polyaniline, polythiophene, polypyrrole, graphite, graphene oxide, carbon coated garnets, nonstoichiometric oxides and perovskites, strontium titanate, titania, ceria, etc.

In some embodiments, the additive may be present at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, etc. within the electrode. In some embodiments, the additive may be present at no more than 90 wt %, no more than 85 wt %, no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of these are also possible in certain embodiments. For example, one or more additives may be present at between 30 wt % and 50 wt %, between 60 wt % and 80 wt %, between 5 wt % and 80 wt %, between 10 wt % and 20 wt %, or the like.

In addition, the electrode may include a binder in one set of embodiments. The binder may assist in the formation of the electrode, e.g., to bind together components such as the active material, and other components (if present) such as additives, particles, fibers, conducting materials, inert materials, particles or fibers, etc. In some embodiments, the binder may include one or more polymers. Non-limiting examples of polymers include polyvinylidene fluoride (PVDF), polypyrrole (PPy), polyethylene oxide (PEO), etc. In some cases, the polymer may be a hydrophobic polymer, for example, a hydrophobic polymer that exhibits an air-water contact angle of greater than 90°, greater than 100°, greater than 110°, greater than 120°, greater than 130°, etc., or other contact angles such as any of those described herein. Additional non-limiting examples of hydrophobic polymers include polytetrafluoroethylene (PTFE), fluoroethers, fluorinated ethylene propylene (FEP), silicone, polyvinylidene fluoride (PVDF), polypropylene, polystyrene, polyethylene terephthalate (PET), or the like. In some embodiments, silicone or silicone polymers may be used. For example, the silicone polymer may be a cross-linked silicone polymer, and or the silicone or silicone polymer may be infused with silicone oil.

In one set of embodiments, the binder may be present in an electrode at at least 1 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, etc. In some case, the binder may be present at no more than 80 wt %, no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, no more than 15 wt %, no more than 10 wt %, no more than 5 wt %, no more than 1 wt %, etc. Combinations of any of these are also possible. For example, a binder may be present at a concentration of between 5 wt % and 80 wt %, between 30 wt % and 50 wt %, between 20 wt % and 45 wt %, etc.

In some cases, the binder may exhibit a contact angle (determined with a surface in air and pure water) of at least 30°, at least 40°, at least 50°, at least 60°, at least 70°, at least 75°, at least 80°, at least 85°, at least 90°, at least 95°, at least 100°, at least 105°, at least 110°, at least 115°, at least 120°, etc. In some cases, the binder may exhibit a contact angle of no more than 120°, no more than 115°, no more than 110°, no more than 105°, no more than 100°, no more than 95°, no more than 90°, no more than 85°, no more than 80°, no more than 75°, no more than 70°, no more than 60°, no more than 50°, no more than 40°, etc. In some cases, the binder may exhibit a contact angle that is a combination of any of these.

The electrode may be in contact with a current collector in one aspect. The current collector may collect current (electrons), which may flow from a first set of electrodes within the apparatus to a second set of electrodes, or vice versa, e.g., as discussed herein. In some embodiments, the current collector may include a relatively inert material for the fluids and/or active materials. Non-limiting examples of materials for use as current collectors include carbon, graphite, titanium, aluminum, copper, stainless steel, platinum, metallic/polymer composites, graphite/polymer composites, or the like.

In certain embodiments, the current collector may take the form of a mesh or fibers, e.g., for use in porous electrodes, and/or flow-through electrodes. For instance, the current collector may comprise a metal mesh, a carbon cloth, or the like. The current collector may also be a solid material in some cases.

In some aspects, a compartment may be operated in an alternating or “rocking-chair” manner, where at a first point of time, a first fluid (e.g., from a first source of fluid) is present in a compartment, and at a second point of time, a second fluid (e.g., from a second source of fluid) is present in the compartment. For example, the first fluid may be a lithium-rich fluid or a fluid rich in another target ion, while the second fluid may be a lithium-poor fluid or a fluid poor in the target ion.

The compartment may be operated in any suitable fashion, e.g., as batch, semi-batch, or continuous processes, etc. For example, in a batch operation, a compartment may be filled, partially or completely, with a first fluid at the first point of time, then the first fluid may be removed and the compartment filled with a second fluid at a second point in time. In contrast, in a continuous operation, a fluid may be passed through the compartment continually, e.g., while a current is applied to the electrodes. Combinations of these may also be used in other embodiments, for example, a first fluid may be contained statically within a compartment at a first point in time while a second fluid flows continuously though the compartment at a second point in time, etc.

In some embodiments, the same compartment can be used for incorporation of lithium (or other target ions) into an electrode, and for removal of lithium (or other target ions) from the electrode, at different times during use or operation. For example, at a first point of time, a lithium-rich fluid may pass through the compartment and lithium incorporated into the electrode, and at a second point of time, a lithium-poor fluid may pass through the compartment and lithium removed from the electrode. Other target ions may be incorporated or removed, in addition to or instead of lithium, in other embodiments.

The switching in a compartment between the first fluid and the second fluid may occur on a periodic or regular basis, or the repetition may occur on an aperiodic or irregular basis in some embodiments. The second fluid can be used for a variety of purposes, e.g., for the production of lithium batteries as a source of lithium, or for other applications such as those described herein. In addition, in certain embodiments, a compartment may be “flushed” between switches, e.g., with a different fluid, and/or by rejecting some of the fluid initially from the compartment after a switch occurs.

In some cases, the flushing or rinse fluid may be chosen to be the same as the fluid most recently introduced into the compartment, although in some cases, the fluid may be a different fluid. For example, additional recovery fluid may be used to flush the recovery compartment after lithium (or other target ion) release from the contacting electrode. The duration and flow rate of a flushing step may be controlled to increase the recovery of additional target ions while minimizing dilution of the recovery fluid.

In one set of embodiments, whenever fluids are switched in a given compartment, fluid mixing may be reduced. Without wishing to be bound by any theory, fluid mixing may be dominated by convection and associated hydrodynamic dispersion. Converging flow fields, e.g., in radial inward flow geometries, may be designed in certain embodiments to limit the total volume of the mixing zone. As a non-limiting example, the mixed volume between two miscible fluids in contact with one another can be estimated in some cases as the product of existing cross sectional area between the two fluids and the mixing zone thickness, approximated by sqrt(2 K t), where t is the residence time and K is the hydrodynamic dispersion coefficient for the channel. Enhanced mixing in turbulent flows may be avoided by maintaining a small Reynolds number in open compartments. Hydrodynamic dispersion may be limited, for example, by reducing the flow rate during fluid switching, by modifying the microstructure to reduce the sizes or thicknesses of channels and/or pores and/or loops in the pore network, etc.

As mentioned, the times in which fluid switches occur may be fixed, or may vary. For example, in one set of embodiments, the fluids are switched at a fixed period or frequency. In another set of embodiments, the times the fluids are switched may vary, e.g., in a regular or an irregular pattern. In some cases, the time when the fluids are switched may depend on conditions within the compartments. For example, in certain embodiments, the fluids may be switched when a certain amount of lithium (or other target ion) has been incorporated, or when a certain current is reached in the flow of electrons between the groups of compartments, etc.

In one set of embodiments, the fluids are controlled using a flow-switching element. The flow-switching element may be constructed and arranged to, at a first time, direct a first fluid from a first fluid source to a first exit and a second fluid from a second fluid source to a second exit, and at a second time, direct the first fluid from the first fluid to the second exit and the second fluid from the second fluid source to the first exit. In some cases, the flow-switching element may, at a first point in time, direct a first fluid from a first fluid source to an inlet of a first compartment (or a first common inlet of a first group of compartments) and a second fluid from a second fluid source to an inlet of a second compartment (or a second common inlet of a second group of compartments), and at a second point in time, direct the first fluid from the first fluid source to the inlet of the second compartment (or second common inlet of the second group of compartments) and the second fluid from the second fluid source to an inlet of the first compartment (or first common inlet of the first group of compartments). In addition, in some cases, the flow-switching element may, at a first point in time, direct a first fluid from a first fluid source to an inlet of a first compartment (or a first common inlet of a first group of compartments) and an inlet of a second compartment (or a second common inlet of a second group of compartments), and at a second point in time, direct a second fluid from a second fluid source to the inlet of the first compartment (or first common inlet of the first group of compartments) and the inlet of the second compartment (or second common inlet of the second group of compartments). The flow-switching element may be a single component, or comprise a plurality of components that together form the flow-switching element.

In some cases, the flow-switching element may allow other fluids to be introduced as well, e.g., into one or both exits. For example, between switches, there may be a period of time where a buffer or rinse fluid can be added, for instance, to separate the first fluid from the second fluid (or vice versa), to permit cleaning of the compartments, or the like.

As another non-limiting example, a flow-switching element may be constructed and arranged to, at a first time, flow a first fluid into some or all compartments of a device, and at a second time, flow a second fluid into some or all compartments of a device. For example, in one set of embodiments, a flow-switching element may be constructed and arranged to, at a first time, flow a lithium-rich (or other target ion-rich) fluid into a compartment, and at a second time, flow a rinse fluid into the compartment. At a third time, the flow-switching element may be constructed and arranged to flow a third fluid into the compartment, e.g., a lithium-poor (or other target ion-poor) fluid into the compartment. In some cases, some or all of the compartments of the device may have the same fluids therein, e.g., as controlled by the flow-switching element.

In some aspects, some or all of the electrodes within a compartment may be connected to each other, e.g., electrically, via one or more electrical pathways. In some embodiments, a voltage may be applied to the electrodes, e.g., creating a potential on the electrical pathway connecting the electrodes. In some cases, this potential may be used to drive the process, for example, to cause faster or better extraction of a target ion. The potential may be applied from an external voltage source, such as a battery, municipal power, or other power source (for example, fossil fuel or renewable power sources).

In addition, it should be understood, however, that in some cases, the potential may be applied to retard the process, which may cause slower or less efficient extraction of lithium or other target ions. This may be useful in some cases, for example, to control the rate at which the target ions are incorporated into or removed from the electrodes.

In some aspects, the second fluid may contain lithium ions paired with anions from the first fluid, such as chloride and/or sulfate, etc. In some embodiments, the second fluid may include reagents that allow the apparatus to directly produce lithium hydroxide, lithium carbonate, or other lithium chemicals.

For example, in certain cases, the second fluid may contain one or more reagents that can be used to precipitate salts of the target ion. For example, if the target ion is lithium, the second fluid (e.g., the lithium-poor fluid) may contain a hydroxide, such as sodium hydroxide (NaOH) or potassium hydroxide (KOH), which may cause the lithium to precipitate as lithium hydroxide (LiOH). The second fluid may have a relatively higher pH, e.g., a pH of at least 5, at least 6, at least 7, at least 8, at least 9, at least 10, etc. In some cases, the LiOH may precipitate in an outlet or exit channel of the compartment.

As another example, in one embodiment, lithium may be precipitated using sodium carbonate (soda ash) to make Li₂CO₃. In another embodiment, lithium may be precipitated using sodium hydroxide to make LiOH. As other examples, sodium carbonate can be used to precipitate certain divalents or multivalents, such as Mg or Ca to form MgCO₃ or CaCO₃, respectively; magnesium may be precipitated using CaCO₃ (lime) to make MgCO₃; or calcium may be precipitated using sodium oxalate to make calcium oxalate.

As another non-limiting example, the second fluid (e.g., the lithium-poor fluid) may contain carbon dioxide (CO₂) and/or carbonic acid (H₂CO₃, e.g., by sparging with CO₂ gas), which may cause the lithium to precipitate as lithium carbonate (Li₂CO₃). The CO₂ and/or H₂CO₃ may be present at any suitable concentration, e.g., a concentration of at least 1 mmol, at least 3 mmol, at least 5 mmol, at least 10 mmol, at least 20 mmol, at least 30 mmol, etc. In some cases, the Li₂CO₃ may precipitate in an outlet or exit channel of the compartment.

An apparatus such as described herein can be used, in some aspects, to extract lithium from seawater, naturally occurring brines, or artificial brines from hydraulic fracturing, nuclear plant wastewater, reverse-osmosis or other water treatment processes, using local fresh water or desalinated water as the recovery solution. In one embodiment, the apparatus can be co-located with a geothermal power plant that produces additional electricity. In another embodiment, the apparatus can be co-located with a blue energy plant at a river estuary. In yet other embodiments, the apparatus can be used to extract lithium from acidic leach liquors from hard-rock mining of spodumene or other lithium containing minerals, or from acidic leachates that arise in Li-ion battery recycling, as a compliment to hydrometallurgical processes. Other applications are also possible in other embodiments.

The following are each incorporated herein by reference in their entireties: U.S. Pat. Apl. Ser. No. 63/440,889, filed Jan. 24, 2023, entitled “Methods and Apparatuses for Galvanic Ion Extraction”; U.S. Pat. Apl. Ser. No. 63/444,484, filed Feb. 9, 2023, entitled “Flow Field Configurations and Methods for Separation Processes”; U.S. Pat. Apl. Ser. No. 63/513,519, filed Jul. 13, 2023, entitled “Methods and Apparatuses for Electrochemical Ion Exchange”; U.S. Pat. Apl. Ser. No. 63/513,532, filed Jul. 13, 2023, entitled “Processes and Apparatuses for Enriching Solutions”; and U.S. Pat. Apl. Ser. No. 63/513,538, filed Jul. 13, 2023, entitled “Flow Systems and Methods for Membraneless Separation.” In addition, the following, each filed on even date herewith, are each incorporated herein by reference in their entireties: a PCT patent application entitled “Methods and Apparatuses for Galvanic Ion Extraction”; a PCT patent application entitled “Flow Field Configurations and Methods for Separation Processes”; a PCT patent application entitled “Processes and Apparatuses for Enriching Solutions”; a PCT patent application entitled “Flow Systems and Methods for Membraneless Separation”; a PCT patent application entitled “Electrode Composites for Electrochemical Ion Separation from Aqueous Solutions, and Methods Thereof”; and a PCT patent application entitled “Apparatuses, Manufacturing, and Operation of Electrochemical Stacks for Metals Extraction, and Methods Thereof.”

The following examples are intended to illustrate certain embodiments of the present disclosure, but do not exemplify the full scope of the disclosure.

### EXAMPLE 1

This example experimentally demonstrates Li extraction and release into solution using lithium iron phosphate (LFP) as a Li-selective electrode material and woven activated carbon as a cation selective element. Lithium iron phosphate electrodes were fabricated by mixing LFP powder, conductive carbon powder, and a polyvinylidene fluoride (PVDF) binder in a solvent of N-methyl-2-pyrrolodone. After mixing, the resulting slurry was coated onto a carbon cloth substrate, by either dip-coating or blade casting, and then dried. To produce a Li-poor electrode, the electrodes were chemically oxidized in a 0.1 M Na₂S₂O₈ solution for 1.5 hours at 50° C., which resulted in an active material with a composition of Li₁₋ₓFePO₄ (FP), where x>0. The activated carbon electrode was either used as received, or chemically modified via a sulfonation protocol.

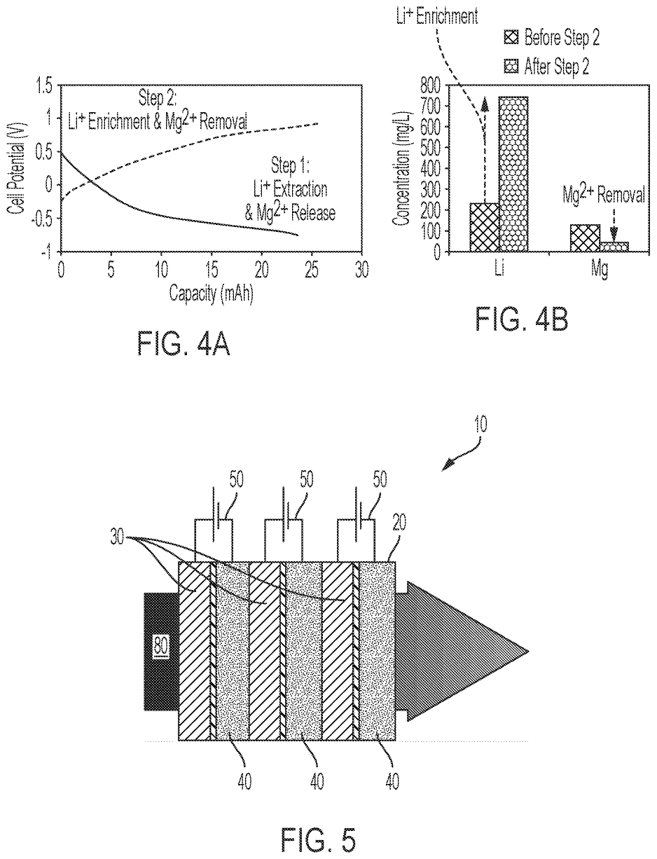

FIG. 4 demonstrates a single cycle of Li extraction and release in a system containing a lithium selective electrode and a counter electrode that is selective toward magnesium. A synthetic brine solution, containing 2100 mg/L Li and 11750 mg/L Mg was flowed through a device containing the two electrodes separated by a porous separator. On the first half-cycle, a negative constant current was applied, simultaneously extracting Li into the working electrode and removing Mg from the counter electrode. This half-cycle is referred to as the “discharge” cycle. After the discharge cycle, the remaining brine was rinsed from the cell and then the fluid was switched to a solution containing 230 mg/L Li, 130 mg/L Mg, and 3900 mg/L K. On the next half-cycle, a positive constant current was applied, which resulted in the simultaneous release of Li from the working electrode and extraction of Mg into the counter electrode (“charge”). The composition of the solution was measured using inductively coupled plasma mass spectrometry.

FIG. 4A shows the voltage of the electrochemical cell over the charge and discharge half-cycles. FIG. 4B shows the measured composition of the secondary solution before and after the charge cycle.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus for electrochemical extraction of lithium, comprising:
a compartment containing a lithium-selective electrode and a multivalent cation-selective electrode;
an electrical pathway connecting the lithium-selective electrode and the multivalent cation-selective electrode;
a source of lithium-rich fluid;
a source of lithium-poor fluid; and
a flow-switching element able to direct fluid from either the source of lithium-rich fluid or the source of lithium-poor fluid to the compartment.

2. The apparatus of claim 1, wherein the multivalent cation-selective electrode is a divalent cation-selective electrode.

3. The apparatus of any one of claims 1 or 2, wherein the multivalent cation-selective electrode comprises a Mg-selective electrode.

4. The apparatus of any one of claims 1-3, wherein the multivalent cation-selective electrode comprises a Mn-selective electrode.

5. The apparatus of any one of claims 1-4, wherein the multivalent cation-selective electrode comprises a Ni-selective electrode.

6. The apparatus of any one of claims 1-5, wherein the multivalent cation-selective electrode comprises a Ca-selective electrode.

7. The apparatus of any one of claims 1-6, wherein the multivalent cation-selective electrode comprises a Cu-selective electrode.

8. The apparatus of any one of claims 1-7, wherein the multivalent cation-selective electrode comprises a Zn-selective electrode.

9. The apparatus of any one of claims 1-8, wherein the multivalent cation-selective electrode comprises a Co-selective electrode.

10. The apparatus of any one of claims 1-9, wherein the multivalent cation-selective electrode comprises a lanthanide-selective electrode.

11. The apparatus of any one of claims 1-10, wherein the multivalent cation-selective electrode comprises an actinide-selective electrode.

12. The apparatus of any one of claims 1-11, wherein the multivalent cation-selective electrode is functionalized with a carboxylic acid.

13. The apparatus of any one of claims 1-12, wherein the multivalent cation-selective electrode is functionalized with a sulfonic acid.

14. The apparatus of any one of claims 1-13, wherein the multivalent cation-selective electrode is functionalized with a phosphoric acid.

15. The apparatus of any one of claims 1-14, wherein the multivalent cation-selective electrode is porous.

16. The apparatus of claim 15, wherein the multivalent cation-selective electrode has a porosity of at least 20%.

17. The apparatus of any one of claims 15 or 16, wherein the multivalent cation-selective electrode has a porosity of at least 25%.

18. The apparatus of any one of claims 15-17, wherein the multivalent cation-selective electrode has a porosity of at least 30%.

19. The apparatus of any one of claims 15-18, wherein the multivalent cation-selective electrode has a porosity of between 20% and 80%.

20. The apparatus of any one of claims 15-19, wherein the multivalent cation-selective electrode has a porosity of between 25% and 70%.

21. The apparatus of any one of claims 1-20, wherein the multivalent cation-selective electrode comprises particles.

22. The apparatus of any one of claims 1-21, wherein the multivalent cation-selective electrode comprises fibers.

23. The apparatus of any one of claims 1-22, wherein the multivalent cation-selective electrode comprises woven fibers.

24. The apparatus of any one of claims 1-23, wherein the multivalent cation-selective electrode comprises nonwoven fibers.

25. The apparatus of any one of claims 1-24, wherein the multivalent cation-selective electrode comprises carbon.

26. The apparatus of any one of claims 1-25, wherein the multivalent cation-selective electrode comprises activated carbon.

27. The apparatus of any one of claims 1-26, wherein the multivalent cation-selective electrode comprises carbon nanotubes.

28. The apparatus of any one of claims 1-27, wherein the multivalent cation-selective electrode comprises graphene.

29. The apparatus of any one of claims 1-28, wherein the multivalent cation-selective electrode comprises a carbon aerogel.

30. The apparatus of any one of claims 1-29, wherein the multivalent cation-selective electrode comprises a first portion and a second portion, wherein the first portion is functionalized and the second portion is not functionalized.

31. The apparatus of claim 30, wherein the first portion of the multivalent cation-selective electrode is in physical contact with the second portion.

32. The apparatus of claim 30, wherein the first portion of the multivalent cation-selective electrode is separated from the second portion.

33. The apparatus of any one of claims 1-32, wherein the multivalent cation-selective electrode is a flow-through electrode.

34. The apparatus of any one of claims 1-33, wherein the multivalent cation-selective electrode comprises a current collector.

35. The apparatus of claim 34, wherein the current collector comprises graphite.

36. The apparatus of any one of claims 34 or 35, wherein the current collector comprises titanium.

37. The apparatus of any one of claims 34-36, wherein the current collector comprises aluminum.

38. The apparatus of any one of claims 34-37, wherein the current collector comprises a metal mesh.

39. The apparatus of any one of claims 33-38, wherein the current collector comprises a porous conducting material.

40. The apparatus of any one of claims 1-39, wherein the multivalent cation-selective electrode comprises an intercalant.

41. The apparatus of any one of claims 1-40, wherein the compartment does not contain a membrane.

42. The apparatus of any one of claims 1-41, wherein the lithium-selective electrode and the multivalent cation-selective are substantially parallel to each other within the compartment.

43. The apparatus of any one of claims 1-42, wherein the lithium-selective electrode and the multivalent cation-selective are substantially perpendicular to each other within the compartment.

44. The apparatus of any one of claims 1-43, wherein the lithium-selective electrode comprises an active material.

45. The apparatus of claim wherein the active material comprises a solid metal.

46. The apparatus of claim 45, wherein the solid metal comprises lithium metal.

47. The apparatus of any one of claims wherein the active material comprises a lithium-ion intercalation material.

48. The apparatus of claim 47, wherein the lithium-ion intercalation material comprises LiMePO₄, wherein Me comprises one or more transition metals.

49. The apparatus of any one of claims 47 or 48, wherein the lithium-ion intercalation material comprises LiMeO₂, wherein Me comprises one or more transition metals.

50. The apparatus of claim 49, wherein the lithium-ion intercalation material comprises lithium iron phosphate (LFP).

51. The apparatus of any one of claims 47 or 50, wherein the lithium-ion intercalation material comprises lithium titanium phosphate (LTP).

52. The apparatus of any one of claims 47-51, wherein the lithium-ion intercalation material comprises lithium manganese oxide (LMO).

53. The apparatus of any one of claims 47-52, wherein the lithium-ion intercalation material comprises lithium titanium oxide (LTO).

54. The apparatus of any one of claims 47-53, wherein the lithium-ion intercalation material comprises nickel manganese cobalt oxide (NMC).

55. The apparatus of any one of claims 47-54, wherein the lithium-ion intercalation material comprises nickel cobalt aluminum oxide (NCA).

56. The apparatus of any one of claims 47-55, wherein the lithium-ion intercalation material comprises lithium cobalt oxide (LCO).

57. The apparatus of any one of claims 47-56, wherein the lithium-ion intercalation material comprises manganese.

58. The apparatus of any one of claims 47-57, wherein the lithium-ion intercalation material comprises nickel.

59. The apparatus of any one of claims 1-58, wherein the lithium-selective electrode further comprises a coating.

60. The apparatus of claim 59, wherein the coating surrounds at least a portion of the active material.

61. The apparatus of any one of claims 59 or 60, wherein the coating comprises the active material.

62. The apparatus of any one of claims 59-61, wherein the coating comprises a lithium-selective material.

63. The apparatus of claim 62, wherein the lithium-selective material comprises lithium titanium oxide.

64. The apparatus of any one of claims 62 or 63, wherein the lithium-selective material comprises polydopamine carbon.

65. The apparatus of any one of claims 62-64, wherein the lithium-selective material comprises carbon nanotubes.

66. The apparatus of any one of claims 1-65, wherein the lithium-selective electrode comprises a ceramic.

67. The apparatus of claim 66, wherein the ceramic comprises alumina.

68. The apparatus of any one of claims 66 or 67, wherein the ceramic comprises titania.

69. The apparatus of any one of claims 66-68, wherein the ceramic comprises zirconia.

70. The apparatus of any one of claims 66-69, wherein the ceramic comprises phosphate glass.

71. The apparatus of any one of claims 1-70, wherein the lithium-selective electrode comprises a conducting additive.

72. The apparatus of claim 71, wherein the additive comprises carbon.

73. The apparatus of any one of claims 71 or 72, wherein the additive comprises graphitic carbon.

74. The apparatus of any one of claims 71-73, wherein the additive comprises carbon black.

75. The apparatus of any one of claims 71-74, wherein the additive comprises graphene oxide.

76. The apparatus of any one of claims 1-75, wherein the lithium-selective electrode comprises a binder.

77. The apparatus of claim 76, wherein the binder comprises polyvinylidene fluoride (PVDF).

78. The apparatus of any one of claims 76 or 77, wherein the binder comprises polypyrrole (PPy).

79. The apparatus of any one of claims 76-78, wherein the binder comprises polyethylene oxide (PEO).

80. The apparatus of any one of claims 1-79, wherein the lithium-selective electrode is porous.

81. The apparatus of claim 80, wherein the lithium-selective electrode has a porosity of at least 25%.

82. The apparatus of any one of claims 80 or 81, wherein the lithium-selective electrode has a porosity of at least 30%.

83. The apparatus of any one of claims 80-82, wherein the lithium-selective electrode has a porosity of between 25% and 70%.

84. The apparatus of any one of claims 80-83, wherein the porous electrode is formed using a porogen.

85. The apparatus of any one of claims 1-84, wherein the lithium-selective electrode comprises particles.

86. The apparatus of claim 85, wherein the particles form a packed bed within the lithium-selective electrode.

87. The apparatus of any one of claims 85 or 86, wherein the particles comprise carbon particles.

88. The apparatus of any one of claims 85-87, wherein the particles comprise Vulcan carbon.

89. The apparatus of claim 88, wherein the particles comprise petroleum coke.

90. The apparatus of any one of claims 1-89, wherein the lithium-selective electrode comprises fibers.

91. The apparatus of any one of claims 1-90, wherein the lithium-selective electrode comprises woven fibers.

92. The apparatus of any one of claims 1-91, wherein the lithium-selective electrode comprises nonwoven fibers.

93. The apparatus of any one of claims 1-92, wherein the lithium-selective electrode is a flow-through electrode.

94. The apparatus of any one of claims 1-93, wherein the lithium-selective electrode comprises a current collector.

95. The apparatus of claim 94, wherein the current collector comprises graphite.

96. The apparatus of any one of claims 94 or 95, wherein the current collector comprises titanium.

97. The apparatus of any one of claims 94-96, wherein the current collector comprises aluminum.

98. The apparatus of any one of claims 94-97, wherein the current collector comprises a metal mesh.

99. The apparatus of any one of claims 94-98, wherein the current collector comprises a porous conducting material.

100. The apparatus of any one of claims 94-99, wherein the porous conducting material has a porosity of less than 75%.

101. The apparatus of any one of claims 1-100, wherein the lithium-rich fluid comprises salt-lake brine.

102. The apparatus of any one of claims 1-101, wherein the lithium-rich fluid comprises geothermal brine.

103. The apparatus of any one of claims 1-102, wherein the lithium-rich fluid comprises artificial desalination brine.

104. The apparatus of any one of claims 1-103, wherein the lithium-rich fluid comprises hard-rock leachate.

105. The apparatus of any one of claims 1-104, wherein the lithium-rich fluid comprises battery leachate.

106. The apparatus of any one of claims 1-105, wherein the lithium-rich fluid comprises seawater.

107. The apparatus of any one of claims 1-106, wherein the lithium-rich fluid comprises a lithium ion concentration of at least 0.2 mol %.

108. The apparatus of any one of claims 1-107, wherein the lithium-rich fluid comprises a lithium ion concentration of at least 0.5 mol %.

109. The apparatus of any one of claims 1-108, wherein the lithium-rich fluid comprises a lithium ion concentration of at least 1 mol %.

110. The apparatus of any one of claims 1-109, wherein the lithium-rich fluid comprises a lithium ion concentration of at least 3 mol %.

111. The apparatus of any one of claims 1-110, wherein the lithium-poor fluid comprises a lithium ion concentration of no more than 0.01 mol %.

112. The apparatus of any one of claims 1-111, wherein the lithium-poor fluid comprises fresh water.

113. The apparatus of any one of claims 1-112, wherein the lithium-poor fluid comprises purified water.

114. The apparatus of any one of claims 1-113, wherein the lithium-poor fluid comprises desalinated water.

115. The apparatus of any one of claims 1-114, wherein the lithium-poor fluid has a pH of at least 5.

116. The apparatus of any one of claims 1-115, wherein the lithium-poor fluid has a pH of at least 6.

117. The apparatus of any one of claims 1-116, wherein the lithium-poor fluid comprises CO₂ at a concentration of at least 1 mmol.

118. The apparatus of any one of claims 1-117, wherein the lithium-poor fluid comprises CO₂ at a concentration of at least 5 mmol.

119. The apparatus of any one of claims 1-118, wherein the lithium-poor fluid comprises CO₂ at a concentration of at least 10 mmol.

120. The apparatus of any one of claims 1-119, wherein the lithium-poor fluid comprises CO₂ at a concentration of at least 30 mmol.

121. An apparatus for electrochemical extraction of lithium, comprising:
a stack comprising a plurality of repeat units, each repeat unit comprising a compartment containing a lithium-selective electrode and a multivalent cation-selective electrode, and an electrical pathway connecting the lithium-selective electrode and the multivalent cation-selective electrode;
a source of lithium-rich fluid;
a source of lithium-poor fluid; and
a flow-switching element able to direct fluid from either the source of lithium-rich fluid or the source of lithium-poor fluid to the compartments within the stack.

122. The apparatus of claim 121, wherein fluid in adjacent compartments within the stack flows in parallel.

123. The apparatus of any one of claims 121 or 122, wherein fluid in adjacent compartments within the stack flows antiparallel.

124. The apparatus of any one of claims 121-123, wherein fluid in adjacent compartments within the stack flows orthogonally.

125. The apparatus of any one of claims 121-124, wherein the stack has a rectangular configuration of compartments.

126. The apparatus of any one of claims 121-125, wherein the stack has a cylindrical configuration of compartments.

127. A method for electrochemical extraction of lithium, comprising:
providing an electrochemical cell comprising a compartment containing a lithium-selective electrode and a multivalent cation-selective electrode;
at a first time, causing current to flow from the lithium-selective electrode to the multivalent cation-selective electrode while flowing a lithium-rich fluid through the compartment; and
at a second time, causing current to flow from the multivalent cation-selective electrode to the lithium-selective electrode while flowing a lithium-poor fluid through the compartment.

128. The method of claim 127, wherein at the first time, lithium from the lithium-rich fluid into the lithium-selective electrode, and at the second time, lithium from the lithium-selective electrode is removed into the lithium-poor fluid.

129. The method of any one of claims 127 or 128, further comprising flowing the lithium-rich fluid through the multivalent cation-selective electrode.

130. The method of any one of claims 127-129, further comprising flowing the lithium-poor fluid through the multivalent cation-selective electrode.

131. The method of any one of claims 127-130, further comprising flowing the lithium-rich fluid through the lithium-selective electrode.

132. The method of any one of claims 127-131, further comprising flowing the lithium-poor fluid through the lithium-selective electrode.

133. The method of any one of claims 127-132, wherein the compartment further comprises an anode.

134. The method of claim 133, further comprising, at the first time, incorporating anions from the lithium-rich fluid into an anode.

135. The method of any one of claims 133 or 134, further comprising, at the second time, removing anions from the anode into the lithium-poor fluid.

136. The method of any one of claims 133-135, wherein the anode is in physical contact with the multivalent cation-selective electrode.

137. The method of any one of claims 133-136, wherein the anode is separated from the multivalent cation-selective electrode.

138. A method for electrochemical extraction of lithium, comprising:
providing an electrochemical cell comprising a compartment containing a lithium-selective electrode and a multivalent cation-selective electrode;
at a first time, flowing a lithium-rich fluid through the compartment, incorporating lithium ions from the lithium-rich fluid into the lithium-selective electrode, and removing multivalent cations from the multivalent cation-selective electrode into the lithium-rich fluid; and
at a second time, flowing a lithium-poor fluid through the compartment, removing lithium ions from the lithium-selective electrode into the lithium-poor fluid, and incorporating multivalent cations from the lithium-poor fluid into the multivalent cation-selective electrode.

139. The method of claim 138, further comprising, at the first time, causing current to flow from the lithium-selective electrode to the multivalent cation-selective electrode, and at the second time, causing current to flow from the multivalent cation-selective electrode to the lithium-selective electrode.

140. The method of any one of claims 138 or 139, further comprising flowing the lithium-rich fluid through the multivalent cation-selective electrode.

141. The method of any one of claims 138-140, further comprising flowing the lithium-poor fluid through the multivalent cation-selective electrode.

142. The method of any one of claims 138-141, further comprising flowing the lithium-rich fluid through the lithium-selective electrode.

143. The method of any one of claims 138-142, further comprising flowing the lithium-poor fluid through the lithium-selective electrode.

144. The method of any one of claims 138-143, wherein the compartment further comprises an anode.

145. The method of claim 144, further comprising, at the first time, incorporating anions from the lithium-rich fluid into an anode.

146. The method of any one of claims 144 or 145, further comprising, at the second time, removing anions from the anode into the lithium-poor fluid.

147. The method of any one of claims 144-146, wherein the anode is in physical contact with the multivalent cation-selective electrode.

148. The method of any one of claims 144-147, wherein the anode is separated from the multivalent cation-selective electrode.

149. An apparatus for electrochemical extraction of target monovalent ion, comprising:
a compartment containing a target monovalent ion-selective electrode and a multivalent cation-selective electrode;
an electrical pathway connecting the target monovalent ion-selective electrode and the multivalent cation-selective electrode;
a source of target monovalent ion-rich fluid;
a source of target monovalent ion-poor fluid; and
a flow-switching element able to direct fluid from either the source of target monovalent ion-rich fluid or the source of target monovalent ion-poor fluid to the compartment.

150. The apparatus of claim 149, wherein the target monovalent ion is positively charged.

151. The apparatus of any one of claims 149 or 150, wherein the target monovalent ion is Li⁺. 152. The apparatus of any one of claims 149 or 150, wherein the target monovalent ion is Na⁺.

153. The apparatus of any one of claims 149 or 150, wherein the target monovalent ion is K⁺.

154. The apparatus of any one of claims 149 or 150, wherein the target monovalent ion is H⁺.

155. The apparatus of claim 149, wherein the target monovalent ion is negatively charged.

156. The apparatus of any one of claims 149 or 155, wherein the target monovalent ion is Cl⁻.

157. The apparatus of any one of claims 149-156, wherein the multivalent cation-selective electrode is a multivalent cation-selective electrode.

158. The apparatus of any one of claims 149-157, wherein the multivalent cation-selective electrode is a Mg-selective electrode.

159. The apparatus of any one of claims 149-158, wherein the multivalent cation-selective electrode is a Mn-selective electrode.

160. The apparatus of any one of claims 149-159, wherein the multivalent cation-selective electrode is a Ni-selective electrode.

161. An apparatus for electrochemical extraction of target monovalent ion, comprising:
a stack comprising a plurality of repeat units, each repeat unit comprising a compartment containing a target monovalent ion-selective electrode and a multivalent cation-selective electrode, and an electrical pathway connecting the target monovalent ion-selective electrode and the multivalent cation-selective electrode;
a source of target monovalent ion-rich fluid;
a source of target monovalent ion-poor fluid; and
a flow-switching element able to direct fluid from either the source of target monovalent ion-rich fluid or the source of target monovalent ion-poor fluid to the compartments within the stack.

162. The apparatus of claim 161, wherein the target monovalent ion is Li⁺.

163. The apparatus of claim 161, wherein the target monovalent ion is Na⁺.

164. The apparatus of claim 161, wherein the target monovalent ion is K⁺.

165. A method for electrochemical extraction of target monovalent ion, comprising:
providing an electrochemical cell comprising a compartment containing a target monovalent ion-selective electrode and a multivalent cation-selective electrode;
at a first time, causing current to flow from the target monovalent ion-selective electrode to the multivalent cation-selective electrode while flowing a target monovalent ion-rich fluid through the compartment; and
at a second time, causing current to flow from the multivalent cation-selective electrode to the target monovalent ion-selective electrode while flowing a target monovalent ion-poor fluid through the compartment.

166. The apparatus of claim 165, wherein the target monovalent ion is Li⁺.

167. The apparatus of claim 165, wherein the target monovalent ion is Na⁺.

168. The apparatus of claim 165, wherein the target monovalent ion is K⁺.

169. A method for electrochemical extraction of target monovalent ion, comprising:
providing an electrochemical cell comprising a compartment containing a target monovalent ion-selective electrode and a multivalent cation-selective electrode;
at a first time, flowing a target monovalent ion-rich fluid through the compartment, incorporating target monovalent ion ions from the target monovalent ion-rich fluid into the target monovalent ion-selective electrode, and removing multivalent cations from the multivalent cation-selective electrode into the target monovalent ion-rich fluid; and
at a second time, flowing a target monovalent ion-poor fluid through the compartment, removing target monovalent ion ions from the target monovalent ion-selective electrode into the target monovalent ion-poor fluid, and incorporating multivalent cations from the target monovalent ion-poor fluid into the multivalent cation-selective electrode.

170. The apparatus of claim 169, wherein the target monovalent ion is Li⁺.

171. The apparatus of claim 169, wherein the target monovalent ion is Na⁺.

172. The apparatus of claim 169, wherein the target monovalent ion is K⁺.

173. An apparatus for electrochemical extraction of lithium, comprising:
a compartment containing a lithium-selective electrode and a monovalent cation-selective electrode, wherein the monovalent cation is not lithium;
an electrical pathway connecting the lithium-selective electrode and the monovalent cation-selective electrode;
a source of lithium-rich fluid;
a source of lithium-poor fluid; and
a flow-switching element able to direct fluid from either the source of lithium-rich fluid or the source of lithium-poor fluid to the compartment.

174. The apparatus of claim 173, wherein the monovalent cation-selective electrode is a sodium-selective cathode.

175. The apparatus of claim 173, wherein the monovalent cation-selective electrode is a potassium-selective cathode.

176. A method for electrochemical extraction of target monovalent ion, comprising:
providing an electrochemical cell comprising a compartment containing a target monovalent ion-selective electrode and a non-target monovalent cation-selective electrode;
at a first time, flowing a target monovalent ion-rich fluid through the compartment, incorporating target monovalent ion ions from the target monovalent ion-rich fluid into the target monovalent ion-selective electrode, and removing non-target monovalent cations from the non-target monovalent cation-selective electrode into the target monovalent ion-rich fluid; and
at a second time, flowing a target monovalent ion-poor fluid through the compartment, removing target monovalent ion ions from the target monovalent ion-selective electrode into the target monovalent ion-poor fluid, and incorporating non-target monovalent cations from the target monovalent ion-poor fluid into the non-target monovalent cation-selective electrode.

177. A method for electrochemical extraction of lithium, comprising:
providing an electrochemical cell comprising a compartment containing a lithium-selective electrode and a monovalent cation-selective electrode, wherein the monovalent cation is not lithium;
at a first time, causing current to flow from the lithium-selective electrode to the monovalent cation-selective electrode while flowing a lithium-rich fluid through the compartment; and
at a second time, causing current to flow from the monovalent cation-selective electrode to the lithium-selective electrode while flowing a lithium-poor fluid through the compartment.

178. A method for electrochemical extraction of lithium, comprising:
providing an electrochemical cell comprising a compartment containing a lithium-selective electrode and a monovalent cation-selective electrode, wherein the monovalent cation is not lithium;
at a first time, flowing a lithium-rich fluid through the compartment, incorporating lithium ions from the lithium-rich fluid into the lithium-selective electrode, and removing monovalent cations from the monovalent cation-selective electrode into the lithium-rich fluid; and
at a second time, flowing a lithium-poor fluid through the compartment, removing lithium ions from the lithium-selective electrode into the lithium-poor fluid, and incorporating monovalent cations from the lithium-poor fluid into the monovalent cation-selective electrode.

179. An apparatus for electrochemical extraction of target monovalent ion, comprising:
a compartment containing a target monovalent ion-selective electrode and a non-target monovalent cation-selective electrode;
an electrical pathway connecting the target monovalent ion-selective electrode and the multivalent cation-selective electrode;
a source of target monovalent ion-rich fluid;
a source of target monovalent ion-poor fluid; and
a flow-switching element able to direct fluid from either the source of target monovalent ion-rich fluid or the source of target monovalent ion-poor fluid to the compartment.

180. An apparatus for electrochemical extraction of target monovalent ion, comprising:
a stack comprising a plurality of repeat units, each repeat unit comprising a compartment containing a target monovalent ion-selective electrode and a non-target monovalent cation-selective electrode, and an electrical pathway connecting the target monovalent ion-selective electrode and the non-target monovalent cation-selective electrode;
a source of target monovalent ion-rich fluid;
a source of target monovalent ion-poor fluid; and
a flow-switching element able to direct fluid from either the source of target monovalent ion-rich fluid or the source of target monovalent ion-poor fluid to the compartments within the stack.

181. A method for electrochemical extraction of target monovalent ion, comprising:
providing an electrochemical cell comprising a compartment containing a target monovalent ion-selective electrode and a non-target monovalent cation-selective electrode;
at a first time, causing current to flow from the target monovalent ion-selective electrode to the non-target monovalent cation-selective electrode while flowing a target monovalent ion-rich fluid through the compartment; and
at a second time, causing current to flow from the non-target monovalent cation-selective electrode to the target monovalent ion-selective electrode while flowing a target monovalent ion-poor fluid through the compartment.

182. An apparatus for electrochemical extraction of lithium, comprising:
a stack comprising a plurality of repeat units, each repeat unit comprising a compartment containing a lithium-selective electrode and a monovalent cation-selective electrode, and an electrical pathway connecting the lithium-selective electrode and the monovalent cation-selective electrode, wherein the monovalent cation is not lithium;
a source of lithium-rich fluid;
a source of lithium-poor fluid; and
a flow-switching element able to direct fluid from either the source of lithium-rich fluid or the source of lithium-poor fluid to the compartments within the stack.

183. The apparatus of claim 182, wherein the monovalent cation-selective electrode comprises a sodium-selective electrode.

184. The apparatus of any one of claims 182 or 183, wherein the monovalent cation-selective electrode comprises a potassium-selective electrode.

185. The apparatus of any one of claims 182-184, wherein the monovalent cation-selective electrode comprises a rubidium-selective electrode.

186. The apparatus of any one of claims 182-185, wherein the monovalent cation-selective electrode comprises a cesium-selective electrode.

187. The apparatus of any one of claims 182-186, wherein the monovalent cation-selective electrode comprises a francium-selective electrode.

188. The apparatus of any one of claims 182-187, wherein the monovalent cation-selective electrode is less lithium-selective than the lithium-selective electrode.
